(19) United States
(12) Patent Application Publication
(10) Pub. No.: US 2012/0221571 A1
(43) Pub. Date: Aug. 30, 2012

(54) Efficient presentation of comupter object names based on attribute clustering

(76) Inventor: Hilarie Orman, Woodland Hills, UT (US)

(21) Appl. No.: 12/737,931

(22) Filed: Feb. 28, 2011

(51) Int. Cl. G06F 17/30

(52) U.S. Cl. 707/737; 707/769; 707/E17.069; 707/E17.089; 707/E17.093

(57) ABSTRACT

A method for discovering and presenting ordered groups of names of objects that are commonly used together by an individual user of a computer system. The invention tracks usages of computer objects and computes a measure of importance (a “weight”) based on attributes such as time of use and other application dependent data. The objects that are commonly used at the same time are called a cluster, and clusters with the highest cumulative weights are the ones a user is most likely to use again in conjunction with one another. A user can select an entire cluster or a subset. The objects with the highest weights in the cluster are presented first when the user, having selected a cluster, needs to select a subset of the objects in the cluster. The invention uses space saving techniques to represent clusters in computer memory.

### BACKGROUND

1. Field of the Invention

Users of computer systems store objects such as files, email messages, chat messages, photos, reminders, data from Internet sites, and locations of Internet sites. Finding the saved objects can be a time-consuming process. This invention makes it much easier and faster for a computer user to find objects that are related to one another. Because the relationships are constructed from a user's own usage history, they are accurate and reliable. The invention makes it possible to construct these relationships quickly, even when millions of detailed records are used for the calculations. This means that the information can be recalculated as often as necessary for up-to-date accuracy, even several times per day.

2. Discussion of Prior Art

Earlier work has made its way into a common feature of computer applications: to present a list of recently used items. A word processor, for example, might present such a list when a computer user selects “open file”. Typically the list is the 4 or 5 mostly recently used files. Our invention is similar, but it gives the application the ability to present groups of files that are commonly used together. For example, if a user opens the file “things-to-do”, she might also typically open the files “school-holiday-schedule” and “recipe-list”. These files would not be on the “most recently used” list, but opening them at the same time, in one step, would save the user time and mental effort in remembering the filenames, folders, etc.

Other manifestations of automating the choice selection occur in commonly seen “auto-completion” interfaces, such as a web browser that automatically completing the typed string “www.g” to “www.google.com”, if that is the most recent use of the string in the user's browsing history. The invention described here is compatible with auto-completion, but the underlying data for auto-completion is based on the history of searches conducted by an individual user, and this yields selections that are more relevant to that individual. Further, the groups of words comprising the user's search history become “objects” in this invention, and those objects are part of an overall usage context for the user. For example, if the user has been reading a text file about penguins and previously searched for “penguins habitat”, this invention combines that search with the text file's name in a “group”, and if the user later selects the file, the methods of the invention will offer the previous search terms as an additional “object” for perusal.

Computer users also use data from a wide variety of sources, including email and Internet sites. U.S. Pat. No. 5,953,720 covers the case of binding together various types of objects into lists so that users can choose from them, but it does not mention the central novelty of this patent, which is to utilize the user's history of selection choices in building the lists. The clustering methods of this invention assure that the lists are highly relevant to the user's current intentions.

U.S. Pat. No. 7,343,365 discusses the use of context in forming selection lists, and its embodiment uses a database for selecting heterogeneous items. This invention differs radically from that patent by its novelty in calculating object clusters (also called “groupings” or “associations”) using a weighted metric based on a linear attribute, such as time, and frequency of common occurrence. The calculation of object clusters further depends on access type (most notably “read” and “write”), and the access types contribute strongly to the accuracy of the method. This invention can discover groups of objects that together form a context of work for the user.

This invention represents the collection of object groups as either distinct entities or as a subset lattice. The subset lattice is a powerful and general way of presenting complex data sets to users. Prior art does not use lattices.

A further novelty of this invention that is not anticipated in prior art is the use of “equivalent” and “subsumed” objects to simplify presentation of the lattice of choices to the user, leading to faster interactions and more efficient use of time spent at the computer.

The methods of this patent are highly efficient and can quickly handle a huge accumulated history of user interactions with computer applications. The methods permit incremental calculation that is very fast and does not lose any of the detail or accuracy of the clusters. Prior art based on relational databases does not easily lend itself to incremental calculation.

### PRIOR PATENTS

“Method and apparatus for a unified chooser for heterogeneous entities” (U.S. Pat. No. 5,953,720; Mithal, et al., Sep. 14, 1999.
“Computer system architecture for automatic context associations” (U.S. Pat. No. 7,343,365; Farnham, et al., Mar. 11, 2008).

### OBJECTS AND ADVANTAGES

This invention accomplishes the objective of quickly and automatically connecting a computer user to the resources needed for accomplishing a task without requiring the user to do any extra work to define the task or its resources. In computer systems in use today, a user must select an object, such as a file or url, by remembering its folder and name and typing those into the “chooser” or selection menu provided by the operating system or an application. In contrast, the invention described here uses past interactions to enable the user choose and use an entire group of heterogeneous objects (a “cluster”, a “grouping”, or an “association”), or subsets of them, in a single act.

Because the cluster formation process is automatic, the user does not have to define tasks and resources or manage the process of forming them. This stands in contrast to many workflow management processes that require task definition in advance of performing the task. The system described in this invention uses the history of a user's previous actions on a computer to infer which objects are related.

The invention is applicable to any computer use for which there is a history and a selection function. For example, Internet search engines take a list of words typed by a user and return results. This invention applies to the history of search terms because the analysis process can form word clusters that are common to several searches and infer that this cluster describes an interest context of the user that will be used in future searches. Typing one word of the cluster will automatically offer the user the option of including all words before adding newer, more specific search terms.

Similarly, the invention applies to email names, calendar events, and many other selection processes on a computer system.

Another advantage of the clustering method is its ability to assist a user in interactively filling in forms for plans. A powerful method for carrying out a complex task is to have a plan “template” or text file with information that a user needs for the task and information that the user must provide. For example, the plan for a trip includes the destination and purpose. The methods described in this invention can easily be applied to templates and to infer that groups of terms are a cluster. For example, the destination “Portland” might be part of cluster of common terms, such as the hotel “Marriott”, the airline “Delta”, and the reminder to “take an umbrella”. When a user selects the destination “Portland” as part of a trip planning template, the associated software can draw on the pre-calculated clusters to interactively fill in the associated terms.

A further advantage of the invention is that its calculations are fast and accurate. They permit incremental computation that can be performed as often as necessary to keep the selection options up-to-date.

Another advantage of the invention is that it can use fine-grained information about user interactions to assure that the clusters are based on significant actions. For example, an email correspondent to which the user frequently sends email is probably more important than one for which the user frequently receives or reads email. The cluster formation process can use this detailed information.

### DESCRIPTION OF DRAWINGS

Figure B is a simplified overview of the method. It shows the collection of history data, the formation of clusters, and the interaction with the user.

Figure Q shows how the history of user interactions is grouped into “time buckets” (intervals of usage).

Figure A shows an example of how a computer application, such as an email system, can be extended with software such as that for utilizing object clusters.

Figure D shows how examples of clusters of heterogeneous objects and how they can be represented in computer memory.

Figure E is a generic representation showing that clusters (time buckets) are ordered by a metric (the “weight”) that summarizes the importance of the cluster.

Figure F shows examples of collections of heterogeneous objects that might be collected based on usage history.

Figure R shows examples of an object index file. This data structure is essential to the high speed calculation of object clusters.

Figure H shows how object clusters are represented in computer memory as nested subsets. This structure makes it easy for a user to select groups of related objects quickly.

Figure I shows a flowchart for selecting objects from clusters represented in the manner of figure H.

Figure J shows a flowchart and data structures for building representations of object clusters that make use of equivalent and subsumed objects.

Figure K shows a flowchart for finding objects that are “equivalent”.

Figure L shows an example of how objects in clusters are classified as “equivalent”.

Figure M shows a flowchart for finding objects that are “subsumed.”

Figure N shows a generic example of how computer memory addresses (pointers) are used to represent subsumed (dominated) objects in a data structure.

Figure O shows a flowchart for carrying out the selection process on object clusters.

Figure P shows an example of a cascaded menu that would be presented interactively to a computer user to select objects from clusters.

### LIST OF REFERENCE NUMERALS

1. The Means for Collection of attribute data
2. Formation of clusters
3. The Cluster Formation Method
4. Constructing weighted a priori tables for objects.
5. Creating subset trees.
6. Definitions:
7. Equivalence processing
8. Subsumption Processing
9. Building a simple indexed lookup tree.
10. “On-the-fly” compact lookup trees.
11. Additional applications

### BRIEF SUMMARY OF THE INVENTION

Computers represent digital objects that are useful to human users. The objects are files, email messages, reminders and access to “world-wide web pages”, etc., and users can choose to access them through presentation methods that offer selections through various interface methods. The methods present the name or title or number of the object in a “menu”, “folder”, “word completion box”, or other user interface mechanisms. The invention has a unique method for organizing the objects based on commonalities. The commonalities are computed using one or more “attributes” of the objects, such as the number of prior uses, their times, and other data such as search terms, file folder names, and email addresses. The ordered presentation is integrated over object types so that, for example, files and email messages that are used together can be retrieved together through the same interface.

The process for grouping objects also applies to smaller items, such as the data in online calendar items, the data in filled-in text templates, destination addresses for email messages, names of email folders, and many other similar items. An object containing smaller data items is called an aggregate object. An examination of history of a user's actions in creating and saving this kind of data is used to produce a list of choices for the user. The choices may be for selecting aggregated objects, or for single items within an aggregated object, or for a set of items that are common to several aggregated objects.

The invention covers finding and collating the objects and associated data (such as time of use, name of email folder, words in an Internet search query, appointments, etc.) as well as forming the aggregates and using them in interactive user selection mechanisms.

### DETAILED DESCRIPTION OF THE INVENTION

Computer systems represent digital objects that are of interest to users of those systems. One type of object is stored on a hard drive in a named file in a file system that is part of the computer's operating system (OS). Other objects relevant to this patent description are represented as data items within named files; these objects can be email messages, reminders, Internet data, Internet locations (Universal Resource Locators or URLs), and several other forms of structured data represented in, for example, databases or HTML (Hyper Text Markup Language) files or XML (Extensible Markup Language) encoded text files. Objects of this kind are used by software applications that “run” or “execute” on the computer.

Computer system users have a display device, such as a cathode ray tube (CRT) or light-emitting-diode (LED) display or a television screen with video or digital input from a computer. The users typically have a pointing device, known as a “mouse”, connected to the computer over a serial line or other low-speed digital communication line. The users further have a keyboard for typing characters, also connected over a digital communication line. These devices may be used with other computers over a local network (LAN) or wide-area network (WAN) using communication protocols between their local computer and remote computers on attached networks.

A computer operating system (OS) can have software that presents a graphical user interface (GUI) and/or a command line interface (CLI), referred to in this document generically as user interfaces (UI). A UI assists the user in selecting objects, such as files or email messages or reminders, for use with software applications running on the computer. The user selects an object by typing its name or using a keyboard or mouse or other hardware to select the object from a list of names presented through the UI. The list of possible selections is called a “menu”. The operating system or UI typically has logic to present an order list of objects that are of common types (such a files, email messages, or name of email correspondents) ordered by alphabet or time of last use, or by “filters” designed by the user, usually involving a formal grammatical construct called a regular expression.

The UI itself typically has a method that allows developers or users to define menus as lists of object names with methods for using the objects. For example, a “web browser” (software for viewing data presented by the Hyper Text Transfer Protocol “http”) can have a “folder” of “bookmarks” that are defined by the user, and when the user selects the folder, the individual bookmark items are displayed, and the user can view an item by using a mouse click, or using a keyboard, or any other interactive method.

When a user selects a menu item, the computer application or operating system performs an action with the item as the object of the action. For example, opening a folder displays a list of the names of items in the folder and possibly the size of the items in bytes and the time of last modification. In another instance, a “viewer” might render the contents of the item as a set of text pages or as a movie. Generally, the result of selecting a menu item is referred to as “opening” the item.

This invention is a way of constructing menus that are based on relationships among objects. The invention has a method for collecting object information and developing groups of related objects. The UI menus have items that represent the groups; when the user selects a group, all the objects in the group are presented in a second menu. The user can “open” any or all of the items in the second menu through an interaction selection method. The group of items is called an object cluster.

[fig-main-flow.png, B] The invention covers three aspects of interactive object selection lists: collecting the data used for calculating the object clusters, calculating the clusters, and presenting the clusters to the user. This is illustrated in Figure B, steps B100, B200, B300.

[fig-bucket-intervals.png, Q] Figure Q illustrated a list of log records (Q100) sorted by time and object ID. Q400 shows how the objects used in the second time interval (index 1) are accumulated into a list RB. The principal bucket list is shown in Q200, and slot Q500 has a pointer to the stored list of object ids. The other record items in slot Q500 are the number of times that particular principal bucket occurs in the time intervals of Q100 (H) and the weight of the bucket (W) which is the sum of the weights for each instance in a time interval.

Also shown in figure Q are the lists of object frequencies (the histogram H, Q300, indexed by object id) and accumulated weights of objects (HW, Q350) also indexed by object id. Q700 shows that the fifth time has index 4.

The members of an object cluster have two essential attributes: a name or other succinct character string that can be used by an operating system or computer application to access the second attribute, the contents of the object or item. The contents are normally an ordered sequence of bytes.

Cluster items may have several other attributes, depending on the type of item.

In the following list of object types and their attributes, the word “date” is understood to mean a time and date with accuracy to at least one second, and it can be represented in any of several formats, such as the number of seconds since Jan. 1, 1970 or Greenwich Mean Time (GMT), month/day/year/hour/minute/second/subseconds, or any other similar format.

Attributes of files: time of creation, times modification (i.e., “writing”), times of access (last time the object was “opened”), times the was opened in “append” mode, number of bytes of data in the file, name of file owner, name of a folder enclosing the file.

Attributes of text files: files containing representations of human readable text can be changed by software applications generically called text editors. The attributes of a text file that has been changed by a text editor include the date on which the contents of the file were written to permanent storage, the date on which the contents were read by the text editor, etc.

Attributes of email messages: email address of the person sending the message, email addresses of recipients, date that the message was sent, date that the message was delivered, dates(s) on which the message was viewed, people to whom the email was forwarded (i.e., sent to other recipients), addressees of replies, the date and place of the disposition of messages into folders or other named repositories. Other attributes include the file names associated with parts of email messages called “attachments” (often encoded in byte stream standard called “MIME”), the name of the file to which an attachment is written, and the names of files that are copied from disk storage that are encoded as attachments in messages sent by the user.

Attributes of calendar or reminder items: time of creation, time of modification, time and date(s) of the appointment or reminder, geographic address or location associated with the item, people listed in the item, keywords or folder names.

Attributes of location names used by web browsers: they are often called Universal Resource Identifiers or URLs. Attributes include the time of last access, title of item as represented in an html or xml “title” construct.

Attributes of searches for Internet sites: some well-known Internet sites are used to search for other sites by using keywords entered by a user. The URL that represents the search site and the search terms is an item with attributes. These can include the time that the search terms were entered, the location on the local machine of a temporary copy of the data returned by the search (this can be a web page cache) and the search terms (keywords) themselves.

Attributes of application programs: when a user runs an application, such as a text editor, this action is often achieved by having the operating system run the software by opening a named file and treating the contents as a set of computer instructions. This is commonly called “executing the program.” Some attributes of an application file are its file type, the owner of the file, the times it was executed, and the parameters used when executing it. The parameters can be of several sorts, including the names of data files. For example, a text editor application would use the name of a file with text to be edited as one of its parameters.

### 1. The Means for Collection of Attribute Data

The attributes described in the preceding sections are necessary data for calculating the object clusters that underlie the invention's core idea of ordered lists of related objects. The attribute data can be collected into files with an explicit or implied representation. For example, the name of a file and a time at which is was opened could be represented in a “comma separated value” format which the items are delimited by commas, as in the following example for the file named “information.txt”,

“file”, “Jul. 17, 2009 17:08:45 MDT”, “information.txt”,“C:/User/joe”, “read”
or the name and access time of a file might be encoded in a tagged format, such as

<object-type>file</object-type>
<datetime>July 17, 2009: 17:08:45 MDT</datetime>
<filename>information.txt</filename>
<pathname>C:/User/joe</pathname>
<access-type>read</access-type>

The object-type is a required field for all records. The “datetime” field is required, although it need not be literally the date and time; the invention only requires that the information have a well-known transformation to an integer or floating point number that has an interpretation as a monotonically increasing variable. At least one additional field must be present in each record; the format and interpretation of this field depend on the object-type, and the invention will use it for identifying an object stored in the computer's persistent memory (disk or media).

In this description, the aggregated information collected by the invention is called the “metadata file”.

The metadata items depend on the object-type. For example, an email message may have items for the sender, the recipients, and user action (e.g. “save” or “forward”). The object-type is always present, as is the time, and as is a unique identifier for the object, such as a file name or application identifier, such an email message-id as defined in IETF RFC822. The invention can use other metadata items for computing objects “weights” when building the clustered objects.

The invention makes use of parsing, a method for interpreting byte strings as objects in a formal language and representing them in computer data structures. These concepts are explained [Aho3].

In this invention, the data for the metadata file is collected in these six ways.

Collecting metadata from artifact files. The invention uses software programs that examine artifacts created by software applications such as log files, history files, file caches, database entries (for example, the databases sometimes known as registries), etc. The software in this invention uses well-known methods to parse the data into the invention's metadata format. The invention requires a list of the location of these artifact files, e.g. in a user's “home directory” or “User data folder” or “Registry labels”.

Collecting metadata through file system scans. The invention uses software that periodically scans the information that an operating system keeps about the file system, notably file accesses and other common user functions. This information is normally part of a directory or folder or other operating system structure that is maintained as a side effect of opening, reading, writing, or executing a file.

The invention uses known methods for finding previous versions of files (commonly known as “backup files”) and comparing the current and previous versions to find differences; if the differences can be recorded in a small number of bytes (typically less than 1000 bytes), then those differences are part of what the invention collects in its log files.

The invention represents the results of scanning the file system in its metadata format.

Collecting metadata from structured files. The invention examines files identified from scanning the file system and parses those files that have structured data. Structured data can be identified either by the file extension (e.g. “csv” for “comma separated values” or “vc” for “VCal” calendar formats) or by an identifiable preamble in the file, such as an HTML (Hypertext Markup Language) or XML (Extensible Markup Language) tag.

Collecting metadata from modified software applications. More metadata can be added by augmenting software applications through interfaces for software developers' interfaces, such as scripting languages (i.e., “elisp” for the file editor “Emacs”; vbscript for spreadsheet applications) or “hooks” or “plug-ins”. For example, every instance of opening files with an augmented text editor can be logged in the metadata file.

Collecting email metadata through examination of email messages and attachments. Two methods are used by this invention. In one, the email handling software (sometimes called the “User mail agent”) has modifications to produce metadata, and in another, the invention examines files containing email messages. In the first method, extensions to “user mail agents” are made through scripting languages, hooks, or plug-ins. The modifications are triggered by user actions, such as replying to an email message or by saving an email message; each triggered action writes a metadata description of the action to a well-known metadata file on the user's hard drive. If the application does not have these modifications, then the invention periodically examines user mail files that have a known structure, and the invention uses text parsing software to interprets email headers and data that are defined the IETF RFC 822, or other information that is encoded in a method used by a software application.

[fig-appext.png, figure A] Figure A illustrates how computer application software in memory (A300) can have an “extension” (A200) as part of its memory image. The software for the application and the extension are stored in the computer's permanent storage, such as a hard drive or disk (A400), so that the same software and the extension are always available for the user of the computer systems.

Metadata collection can also be achieved by examining the auxiliary files that Internet web browsers typically keep about user's history of website visits; these files have lists of Universal Resource Locators (URLs) that have website names, visit date, and parameters (e.g., an Internet “search” request typically encodes the search words in the URL).

Metadata collection can also be achieved by recording data about application usage through software “wrappers” that are invoked prior to and after the application execution; the invention wraps some applications in a “shell script” that records data in a text log file on the computer system.

### 2. Formation of Clusters

Object clusters are groups of items that are likely to be used simultaneously by a computer user. “Simultaneous use” can mean that a user will “open” or select or access the objects from software applications within a small time interval, typically less than an hour. “Simultaneous use” can have an alternative meaning of binding several attributes together for use in a discrete action such as sending and email message to several recipients. Cluster in this invention are items used “simultaneously” in the past; such usage is taken to be predictive of future use patterns.

Object clusters are of two types: those computed using time or other ordered attribute data as an input parameter and those that do not use such data.

The likelihood (or probability) of two objects or parameters being used simultaneously is based on the history of the user's actions on the computer. In this invention, the history is the contents of the metadata log files.

Some object-types in the logfile have well-known identifier formats, such as an email message-id or a full pathname for a file. These object identifiers in the logfile must be unique and their representation must be such that an identifier can be used by at least one software application to find the object and present it to the user for viewing or editing. In this invention, object identifiers consist of the object type and a string of bytes that constitute a unique “name” for objects of that type. For example, the pathname and filename of a file on a computer constitute such an identifier, for example pathname “C:/User/Joe” and “joesdoc.doc” could be a pathname and filename that constitute an identifier for an object of type computer file, and the extension “.doc” can be used by the operating system to select an appropriate viewer or text editor.

Although most object-types have a single character string that is a unique object identifier, others, such as calendar entries or “contacts” (people and their contact information), are not as strictly defined. In this invention, an object type can be the concatenation of several text fields (such as “fullname” and “title”) to serve as the object identifier in the methods described below.

The object-type and identifier data are an efficient representation for the processing described below, and those skilled in writing software for computers will recognize that an alternative representation can be calculated easily. The alternate representation has a sequential array of addresses in the computer memory; we use the name I for the array, see D200 in figure D. Each address points to a portion of the computer memory that contains the bytes representing an object-type and identifiers. No two addresses in I point to the same byte string nor to byte strings that have identical representations. This is an “index” for the objects. The address stored position zero in I points to the bytes for an object-type and identifier, the address stored in position one in I points to the data for a different object-type and identifier combination, etc. The index I makes it easy to use an integer to represent an object; the computer instructions use the position number within I to stand for the object. Objects can be compared for equality by using the integer representing their offset in I instead of the longer byte sequences for object-type and identifiers.

[fig-obj-index.png, D] In Figure D, D250 shows a pointer to a memory array with a record (D220) of type “file”, and other pointers to varying record types, such as “email” (D210), “calendar” (D230) and “url” (D240). These are illustrative examples of some of the records that are used by the invention.

The invention makes use of arrays as data structures. Those familiar with computer software will recognize that there are many ways to represent arrays [Aho3, Ritchie]. This invention uses arrays in which the size is known at the time the computer memory for the array is allocated (fixed size arrays) and those which grow in size as elements are appended (variable size arrays and lists [Aho3, Ritchie].

A set of object identifiers can be represented in computer memory as an array or a linked list, using any well-known techniques [Knuth, Ritchie, Aho]. There are well-known techniques for representing arrays and lists in a computer memory, and there are well-known methods for making changes to the arrays or lists, by adding or deleting elements. In the following, large, sparse arrays (those with a small percentage of non-zero elements) should be represented as linked lists because they use less computer memory. “Sparse” arrays have fewer than 10% of their elements non-zero, and “large” arrays are those that require 25% or more of the computer's main memory or Random Access Memory (RAM).

Object deletion is done by setting the object id in B[n] to a well-known “null” value, such as −1, or by modifying the list or array structure of B[n] using any of various efficient methods such as those described in [Ritchie].

The invention makes frequent use of sorting, a technique described in [Knuth]. The “keys” in sorting are data items within records, and the records are reordered in the computer memory according to a predicate that can compare two items and indicate whether or not the first item is “greater” than the second. For integers, the predicate is the arithmetic function “greater than”; for character strings, the comparison is done with multi-byte strings that have a null character as the termination indicator. Sort keys are ordered, and if the predicate indicates that two records do not satisfy the predicate for the current key, then no further key predicates are used. The first key is the “primary” key, the second key is the “secondary key”, etc.

In order to build object clusters, the computer processing sequence of this invention must first examine a metadata log file, sort the entries by object-type as the primary key and identifiers as lesser keys (each object-type may have a separate way of sorting its object identifiers), and remove all duplicate objects. The number of remaining objects is the size of the index array I, and each object's address in the computer memory is copied to I in turn, the first object address going to position 0 in I, the second to position 1, etc. This invention uses an index array for objects and a different index array for bucket identifiers.

In this description, the size (i.e., number of entries) of an index array I is denoted as “cI”.

After building the index, the records in the metadata log file can be simplified by removing the object type and associated identifiers and then by replacing the object type by the index of the object in I.

In the following description, any reference to “object type and identifiers” or “object identifier” can be replaced by “the index in I of the object-type and identifiers”. The computer operations for comparing and sorting objects are then understood to be operations on integers in the computer memory instead of operations on byte strings.

The clustering algorithm for objects with attributes with a single linearly ordered variable, such as date/time, called “T”, has several steps described below. After this processing, there may be fewer buckets, and there will be a measure of bucket “importance” as characterized by the weight function. This is illustrated in the diagram of overall processing as the third step “Analyze and Cull.”

[fig-timebuckets.png, E] Figure E shows the results of ordering buckets by weight. E200 is the array with the weights and pointers to buckets. E210, E220, and E230 are example buckets each bucket is a list of records of timestamped items and optional attributes. The records within buckets are, in this illustration, “abstracted”, that is, the illustration does not have details of the attributes, time, etc.

The invention uses the parsed metadata log records to find “principal buckets”. The software first creates an array PI for holding principal bucket records. The array should either be variable length or have at least Nb entries. Addresses of buckets will be placed into PI, starting with the first location and proceeding sequentially.

### 3. The Cluster Formation Method

Cluster Step 1. Make the metadata log file available in the computer memory, either by “opening” a pre-existing file or by parsing the data in application log files (described in the previous section “Means of collection of attribute data”) into records that use the format of a metadata logfile.

Cluster Step 2. Sort the metadata records, using the linearly ordered attribute (T) as the primary (i.e., highest priority) sort key and the object type as the secondary key and the object name (or index) as the tertiary key. The other attributes can be ignored or used as lesser keys.

Cluster Step 3. Choose an interval ti as a small fraction of the number of units in the range of the variable T. The interval can be any value, but if T is time, useful values are typically between 5 and 60 minutes. This description uses the notation Time(i) to mean the interval from Te+i*ti to Te+(i+1)*ti.

A variable C will hold the count of the number of intervals that have objects in use. The variable has the initial value zero.

Cluster Step 4. The minimum value of T is the “epoch”; the “current epoch” Te will begin with that minimum value and increase monotonically by ti. For each interval, the invention determines 4 things: the ordered list of objects in use during an interval Time(i) (referred to as the set B, a “bucket”), the weight of B, an optional “hash” value of the set B, and a pointer to “other” data.

Before processing the log records in an interval, the invention sets the variable length array RB to be “empty” (i.e., the array has no elements).

The invention examines the sorted log records sequentially, starting from those with timestamps in the interval Time(0). If the object's log record has a timestamp in interval Time(i), then the object referred to by the record was “in use”, and the object's identifier is put into a variable length array RB, which is the working storage for the current interval. If the object is already listed in RB (determined by searching RB), then it is not added again while processing the current time interval. When finding the first item in an interval, the processing sequence adds 1 (one) to the variable C. This method is called the “no-metadata-weight” clustering method.

The insertion of an object identifier into the RB list is by appending the identifier to the list. Because the records in a time interval are sorted using the identifier as the primary key, the list RB preserves that ordering.

The invention uses a second calculation that can be done for each object as it is processed to an interval of use. A log record for an object will have its time of use and other metadata, such as its type, mode of use, and other related information. The invention uses a function WO that uses the metadata to compute a “weight” for that instance of object use. The weight of an object in an interval is the sum of the function WO evaluated on each of its log records for that interval. The members of the set B[n] are tuples (arrays of length 2), where each tuple contains the object identifier and its total weight for that interval. This method is called the “metadata-weight” clustering method.

The invention uses object attributes in the log file as part of calculating WO. The is another weighted function A[y,n] that takes two input values, the representation of type of an attribute (for example, “email” or “url”) and the action performed on it (for example, “reply” or “bookmark”). The function A produces an output value that is an integer or floating point number. A is a function defined by a table or array. For example, A might have these entries: email, “read”=1, “save”=2, replay=“4”, “forward”=3″ url, “read”=1, “bookmark”=4, “view source”=1. The weighted rank of an object is modified in this invention by multiplying the object weight WO by the value of A as evaluated on the object's type and named attributes. If more than one attribute is applicable, then the value of A is used for each one, and all are added to WO. In this invention, attributes that modify content (i.e., by writing, changing or appending data) have a higher A value than those that do not. In general, A(attributes) is an rational number near 1.0.

If an object such as O1 is used more than once in a single time interval, then the weight for each instance is added to its entry in RB.

The invention includes an optional calculation that implicitly includes an object use record in every time interval between an “open” and “close” operation. When using this part of the calculation, the invention maintains an associative memory table of objects indicating whether they have been opened and whether they have been closed. If an object is opened and is not in the table, it is added to the table with status “open”. If the log record shows that the object has been “closed”, then its state is changed to “closed”. If an object is already in the table with state “closed” and the log record for it is “open”, then its state in the table is changed to “open”. For each interval, the invention processes all the records in the interval and then process the table of open object. If an object is in the table and has status “open”, but the object does not have a log record for the current interval, the invention nonetheless adds a record of type “use” for that object and for the current interval. This will result in incrementing the “weight” of the object. To guard against cases where the “close” operation might have been omitted from the log, the invention uses a timeout value, so that after the timeout interval has been exceeded, the object status is changed to “closed”.

Figure Q shows a diagram of a sorted list of records and the time interval ti (the second time interval, after the interval from Te to ti) in Q100.

The alternate method (1) for computing the data in RB uses a wider time interval with overlap between adjacent intervals. If an object is in use at time between Te+i*ti and Te+(i+1)*ti+ti/4 then it is collected into RB.

Alternate method (2) for constructing buckets uses time intervals that overlap ty ti/2. Objects in time interval Time(i) are used in forming buckets, and so are objects used in interval Time(i−1/2) (i.e. starting at Te+i*ti−(ti/2) and ending ti units later) are collected and used in computing principal buckets.

After processing the Nb time intervals in this sequential manner, the records in each B[n] (i.e., the list of bucket members in the memory area pointed to by element n of table PI) are in the same relative order as they were after Cluster Step 2, where the object identifier was the primary key.

Cluster Step 5. The invention forms a histogram H (an array of positive integers) of the frequency of occurrence of individual objects in the set of all B[n]. The multiplicity of the objects in a bucket B[n] is not used, only their presence or absence. The histogram is an array of integers with a size equal to the total number of unique objects (denoted as cI in this description). The computer processing sequence examines each bucket B[n] and each member of a bucket, and it adds the integer 1 to location H[i], where i is the identifier index for an object. An object might occur more than once in a bucket; its histogram entry is incremented only for the first occurrence.

The invention can use an alternate method for incrementing the histogram entries. In that method, the object identifiers in a bucket B[n] are sorted in ascending order before they are scanned for the histogram. The software examines each entry in the sorted bucket, and it stores the value of an entry in a variable Prev. If the next entry is the bucket is equal to Prev, then its histogram value is not incremented. If the next entry is not equal to Prev, then the variable Prev is set to the current entry's value.

The invention covers the case in which the weighting function WO has been used to compute the weight of each object in B[i]. At the time the weight is computed, the invention utilizes a second array HW, in which all entries have the initial value zero. The weight of an object O is added the object weight array HW in location HW[O], where O is the integer representing the object identifier.

The invention also forms a histogram H1 with the size of each principal bucket in PI. If the bucket for PI[n] has 5 members, for example, then H1[n] is set equal to the integer 5. This is done while PI is being built.

Cluster Step 6. Set a threshhold value Hhi between 0 and 1 (an example useful value is 0.33). Using the histogram in item 5 above, find the objects that occur in more than H multiplied by C (H*C) of the B[n]. Delete those objects from all buckets B[n]. When deleting an object, subtract 1 from its entry in the histogram H, and if the object is a tuple, subtract its weight from histogram HW.

Cluster Step 7. Set a threshhold value Hlo between 0 and 1 (an example useful value is 0.01). Using the histogram in item 5 above, delete from the B[n] those objects occurring in fewer (or having a lower normalized weight than) than H multiplied by C (H*C) of the B[n].

Cluster Step 8. Culling very large buckets and very small buckets. Find the largest value in the histogram H1 (i.e, the size of the largest bucket). Select a rational number between 0 and 1 as the “size pruning fraction” SP. A useful value for this number is 0.96 (i.e., 96/100). Remove any buckets with more than SP elements. Remove all buckets that have only one element. When a bucket B[i] is “removed”, the i-th element of the PI array is set to zero, and the computer memory area holding the elements of B[i] is deallocated and made available for other uses.

Cluster Step 9. Sort each non-empty bucket using the object identifier as the sort key. The sorting step is not necessary if the method for forming the buckets proceeded in order through the objects and inserted new objects into the end of each bucket.

Cluster Step 10. This step determines which buckets have exactly the same members. When two or more buckets have the same members, those items are a “cluster” and their likelihood of being used again in the future is an important piece of information in the User Interface of this invention. A set B[i] is called “equal” to B[j] if and only if all the object identifiers in B[i] are in B[j] and vice versa. If, for all B[j] that are equal to B[i], i is numerically less than j, then B[i] is the principal representative of that set of identifiers. The cluster processing finds principal representatives by collecting object identifiers into working memory RB, and by comparing its object identifiers to the object identifiers in the buckets pointed to by the “principal bucket array” PI. The multiplicity of an object identifier in a set is not used in the comparison.

If the object set for interval Time(i) is equal to an object set PI[k] in PI then the invention adds the weight of RB to the weight of PI[k]. If the members of buckets are represented as tuples, then the invention adds the T-adjusted (see the definition of F(T1,T2) below) average of the weights of the objects in B[i] to the weight of the corresponding object in the object list PI[k].

In the determination of principal buckets, the computation of set equality is much faster if the set members (the object identifiers) are reduced to small integers using “hashing”. Hash functions such as Bloom Filters [Bloom] or MD5 [RFC1321] can be used. If the hash function computed on two sets has the same value, then the two sets are equal with very high probability, and an element-by-element check for exact equality is done. If two sets have different hash function values, then they definitely are not equal.

The bucket comparison could be additionally made faster by creating an array records that contain the bucket index of RB and the hash of the bucket members. That array can be sorted by using the hash index as the primary sort key and the bucket index as the secondary sort key. After sorting the records, all equivalent records (those with the same members) will occur sequentially in the computer memory. By examining each element in that array in sequence, the processing sequence will take the first record with a new hash value and enter its RB record into the PI array. Subsequent records with the same hash value are accumulated into the principal bucket record as described above.

In this invention, the T-adjustment to an object weight is done using a special function F(T1,T2). This function takes as its input two values for a linear variable such as time, where T2 is greater than T1, and its output value is an integer or floating point number that is monotonic decreasing with respect to T2 minus T1. In this invention, a useful definition for F is a histogram with C entries. L1, L2, and L3 are adjustable values that are greater than C/2 and less than C.

F[T,T]=C,

F[T−1,T]=C/2,

F[T−ne,T]=C/(2expi) if i is less than L1.

The expression (2 exp i) is “2 to the power i”, the exponentiation function.

if i>L1 and i=<L2, F[i]=2
if i>L2 and i=<L3, F[i]=1
if i>L3 F[i]=0.

This is an example of a discrete function that is approximately “heavy-tailed” (such as a Pareto distribution [Pareto]). In this invention, any similar function, such as a discrete approximation to a reciprocal or hyperbolic function, is a useful function for defining F.

The T-adjustment for object bucket weights in time interval Time(i) uses the value of the epoch, Te, as the first parameter for function F and index i multiplied the time interval ti as the second argument.

The weight of the time bucket associated with interval i is multiplied by the value of F(Te, i*ti). That result is added to the weight of the principal bucket PI[k] associated with the object list for the time bucket.

Cluster Step 12 (final step). Order the list of principal buckets by their weights, using sorting on the array PI, and using the weight item in each record as the primary sort key.

In one cast of the invention, the set of principal buckets represent “super-objects”, and if a user interactively selects a super-object, all the objects are made available to him through their associated software applications, just as if the user had selected each object individually. For example, if the super-object contains a file with the identifier “/home/joe/addresses” and an email message with the identifier “/home/joe/Mail/Inbox msgid 131459”, then the file would be opened in the default text editor and the specific email message with the unique identifier “131459” would be opened in the software application that is the user email agent.

[fig-object-menu.png, F] Figure F illustrates some examples that might be super objects for a typical user. The figures show how the objects might appear to a user in a menu-drive GUI. Object 1 (F101) has an email message with the subject line “How are you”, a URL titled “Allison's home page”, and a hard drive file with the name “groceries.txt”. By clicking on a super object the user can indicate that all of the objects should be “opened” by the appropriate associated application (e.g., email reader, web browser, text editor, respectively).

The weight of a super-object can be interpreted as its “importance”, and thus, the most important super-objects are the ones that a user is most likely to want to access, and the members of a super-object should be presented to the user, through the interactive selection interface, as a group that is ready for immediate use.

The group representation makes it possible for a user to select super-objects through a user interface mechanism. The super-object's visible representation can be accomplished through a text display of all the object names (derived from the records describing the objects) in a text list, or by displaying those object names in a graphical representation of a list. If a user selects an object name, the user interface mechanism will generate a new display, using only those super-objects that contain the selected object. This process continues until the user either chooses a selection “all” to use the union of all objects in all remaining super-objects, or chooses the menu selection item of the super-object with the highest weight.

It is important to note that the invention does not need to use old logfile data when updating the clusters to include recent user actions. If the cluster computation is uses time as the linear variable, then all older results are “demoted” using the weighting function. For example, all current weights of superobjects and members of clusters can have their weights decreased by a multiplicative factor of one half. Then new data can be analyzed using the usual weighting functions, and then the results are added into the appropriate clusters.

### 4. Constructing Weighted a Priori Tables for Objects

Another form of the invention constructs tables that are useful for allowing a computer user to select an object group (bucket B) interactively. The invention shows the user the available objects, and the user selects one object at time. After each selection, the invention recomputes the available objects based on the principal buckets that the selected object occurs in, and then shows the user which ones are available for selection. This section of the invention describes the construction of the data organization structure that allows the selection process to be done efficiently, even for large datasets.

The records and tables can be constructed from several different arrangements in the computer memory, according to methods well-known to software practitioners. The computer memory can be contiguous, or it can be a series of contiguous blocks connected through pointers, or it can be an associative database. The descriptions and examples in this document are efficient and simple.

“Records” are computer data structures with one or more elements. “Typed” records have an identifier in a fixed position that has a bitstring with the record type. Each type uses a different identifier. This invention uses typed records for building lookup tables. Typed records not the sole representation that can be used for the data, but they simplify the explication.

This invention uses seven types of records when building lookup tables: object, lookup table, index table, bucket, bucket set, subsumed, and equivalence. The invention begins with a bucket set, specifically, the array PI computed by the cluster algorithm. A fully completed table is a lookup table that has only lookup table records and equivalence records.

An “object record” has two elements: an object id and a pointer to the memory location of another record.

An “index table” record is a array with cI entries, one for each unique object in the original bucket set TB. If an object's identifier is “n”, then it is the “nth” item in the table (i.e., all index tables have the same size). The items in the array are pointers to other records. An index table is optimized for speed.

A “lookup table” (also called “normal”) record has a list of object records, one for each object that co-occurs in a bucket with the particular object id. The records are ordered by the object weights as calculated in the description following these record definitions. This record also has an integer representing the size of the table, which is normally the number of unique objects in the original bucket set TB (cI).

[fig-numeric-index-table, R] In figure R, there is an example of an index table, R100. The size of the table (or array) is 1213 which represents the number of unique objects. The first object, with index 1, has a memory pointer to a character string (R200) that is the name of a file on a hard drive. The next entry in the table is for index 2, and that has a pointer (R210) for a character string that represent the unique id for an email message.

A “bucket” record is a tuple consisting of the list of object ids in the bucket list and the bucket weight as computed in the clustering steps above.

A “bucket set” is a list of bucket records.

A “subsumed” record has two elements: the object identifier of the subsumer and a pointer to a lookup table record.

A “equivalence” record has an array of object ids.

This description first describes how to build weighted a priori lookup tables starting with a list of buckets. The table is called “a priori” because the at each level of the lookup table, the weights of the objects are recalculated; the recalculation uses the objects and their weights, exclusive of the objects that have already been selected, i.e., the “a priori” selections. This first method uses only the record types of “lookup table”, “index table”, and “bucket”. Later, it describes modifications that use the other record types to build tables that use less computer memory and require fewer computer instructions for lookups.

The set of principal buckets as computed in the array PI is the basis for building an ordered object lookup table, TK. A lookup table has a graph structure that can be described as a tree; each node comprises an object and a subtree. Each entry in the table is a record with two items: the index (object id) for an object K and the address of another lookup table. The lookup table for an object A has a list of all objects that co-occur with A in the buckets of the PI array. A special index, such as −1, when used as the second item, means there is a third entry is the address in memory of a list of the names of objects that can be used by software applications on the computer (e.g. filenames, keywords, Internet locations, email addresses).

Building the lookup table requires finding all the buckets containing an object K, deleting K from each bucket, and then building a lookup table for this reduced set of buckets. This is a recursive process, and in order to minimize computer memory usage, the invention uses “depth-first” recursion. “Breadth-first” is also possible, as an option noted below.

The determination of principal buckets in the array PI was described in the previous section. A side-effect of this calculation was the creation of an array of objects weights, H.

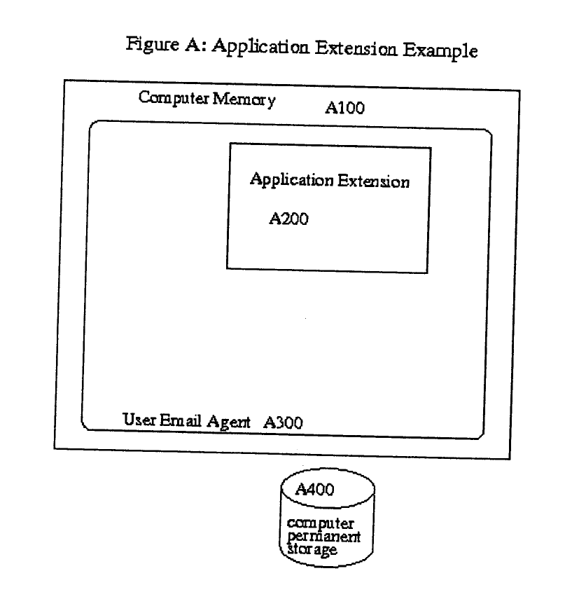

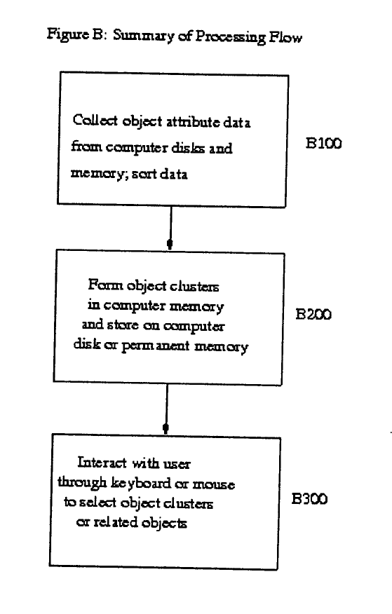

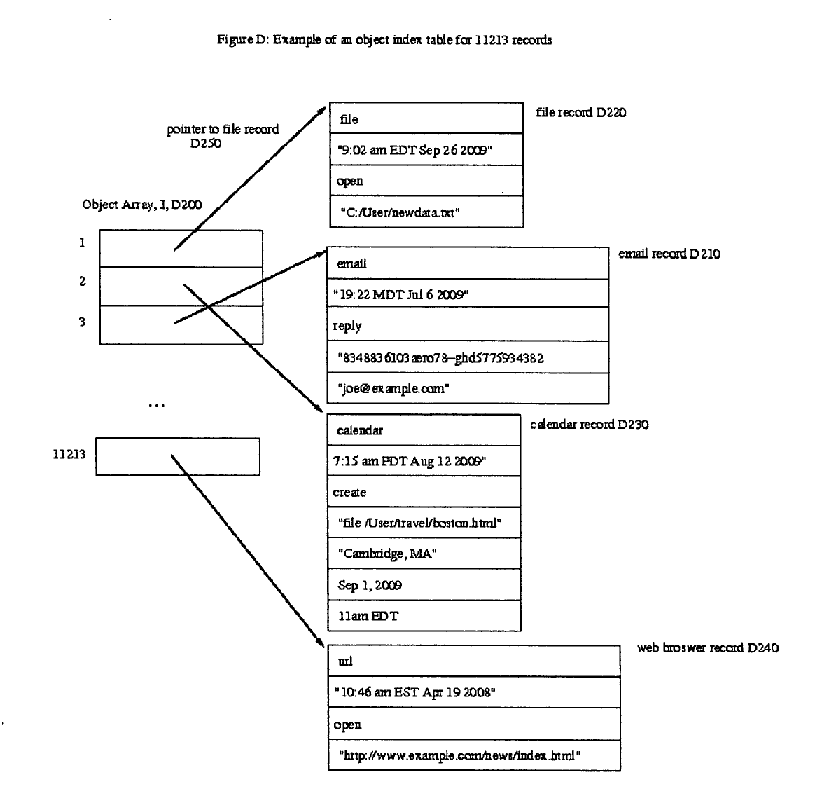

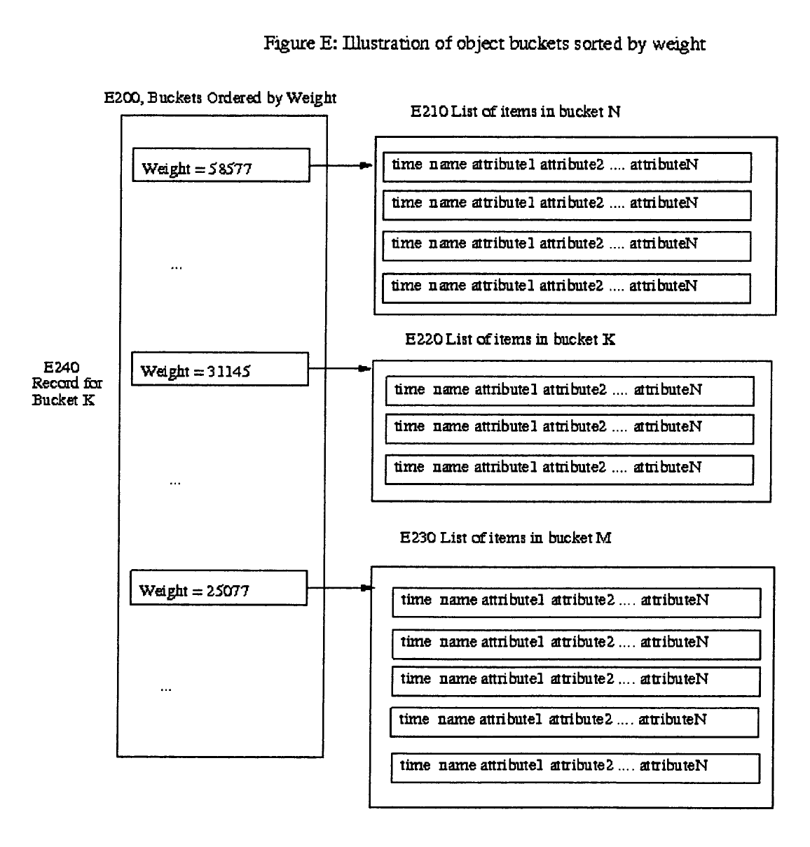

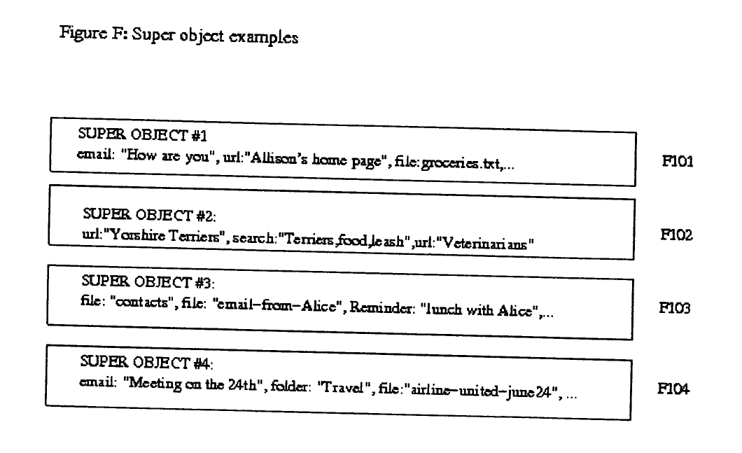

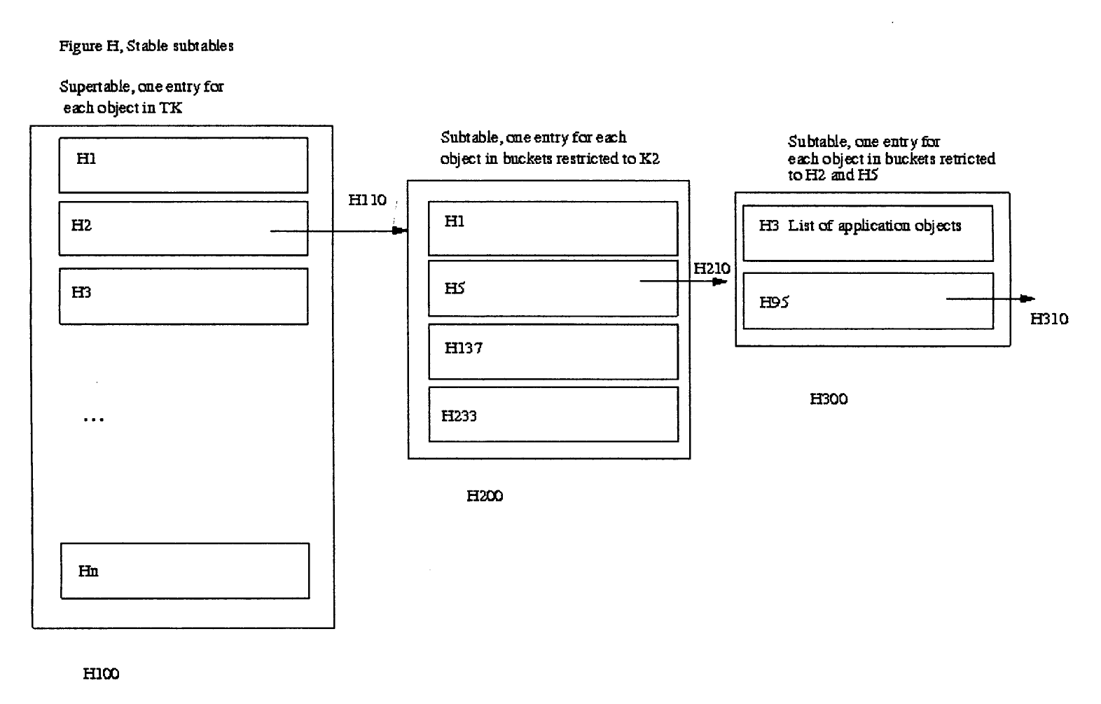

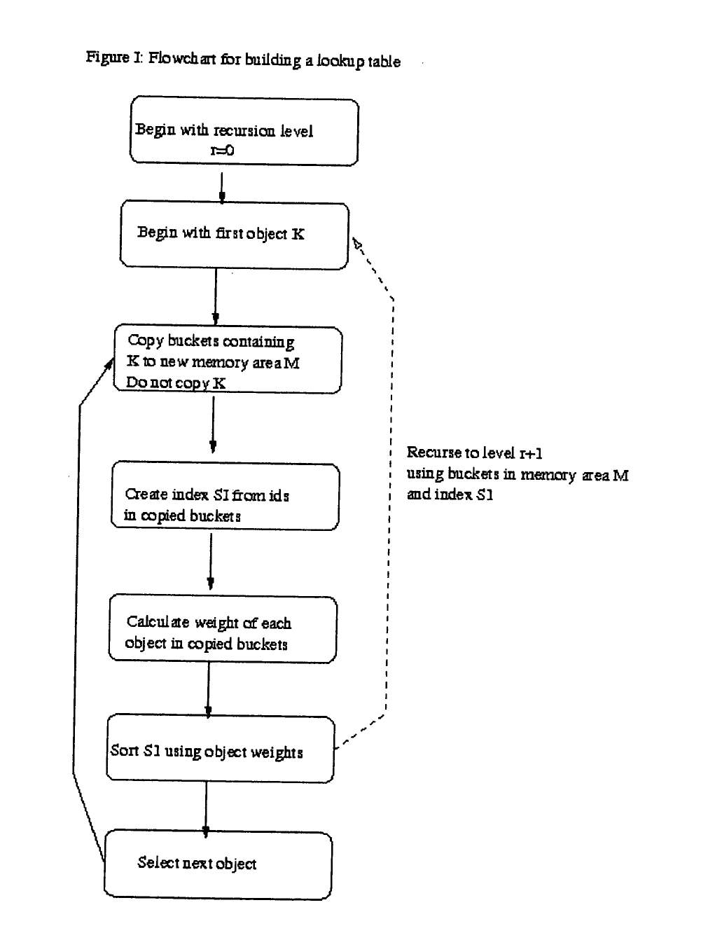

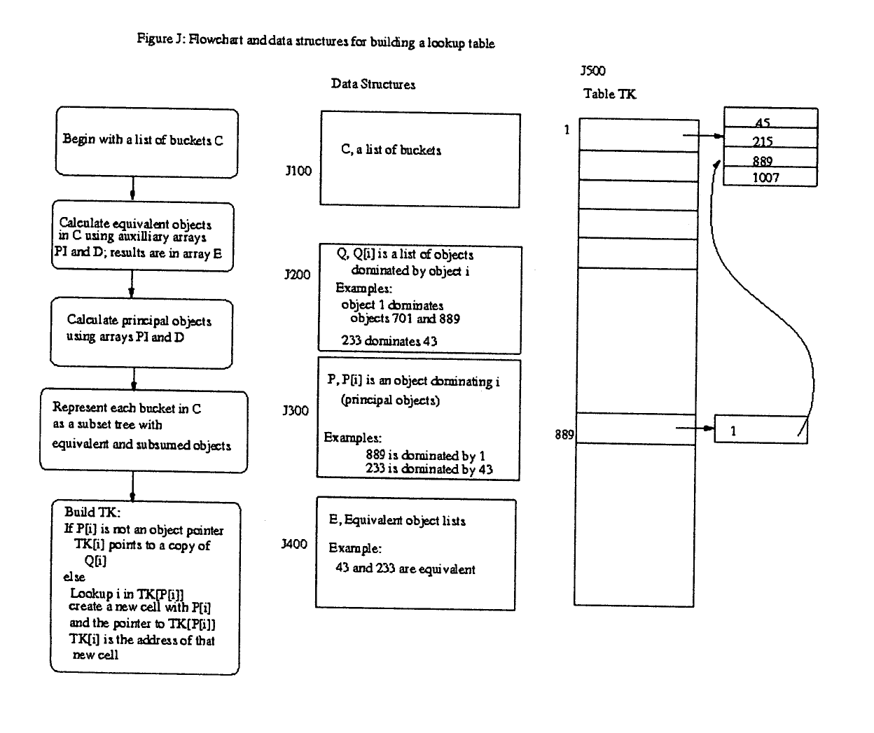

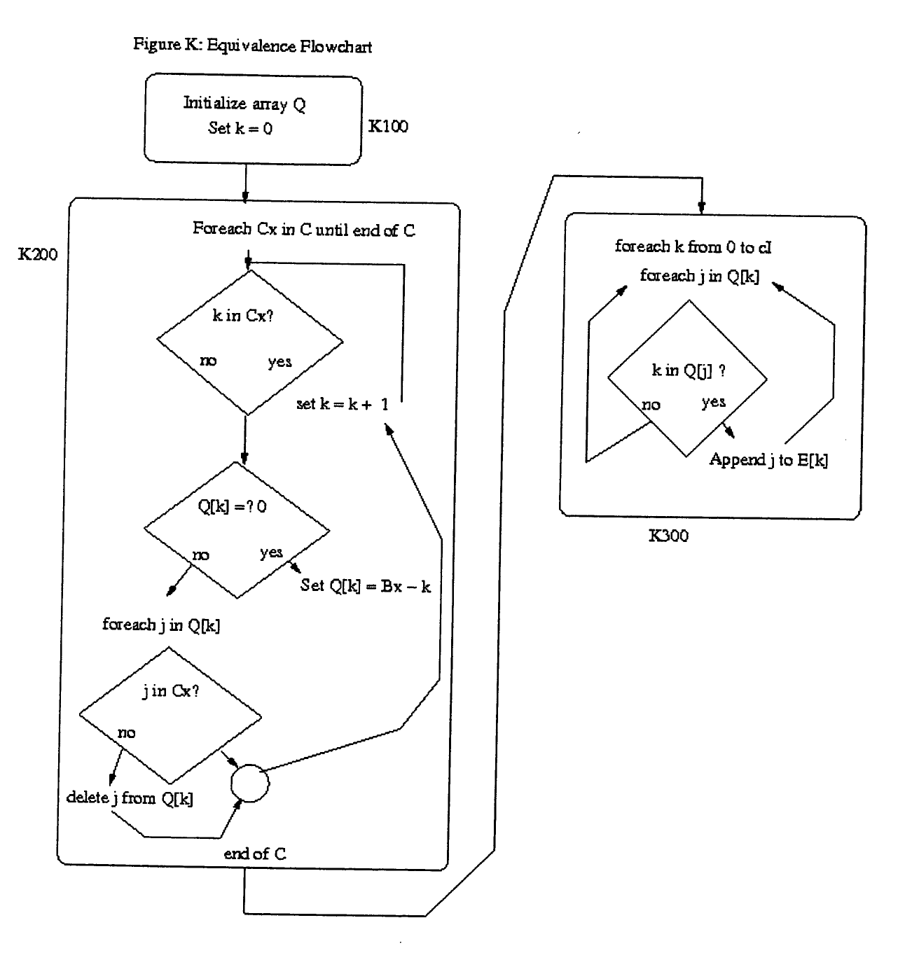

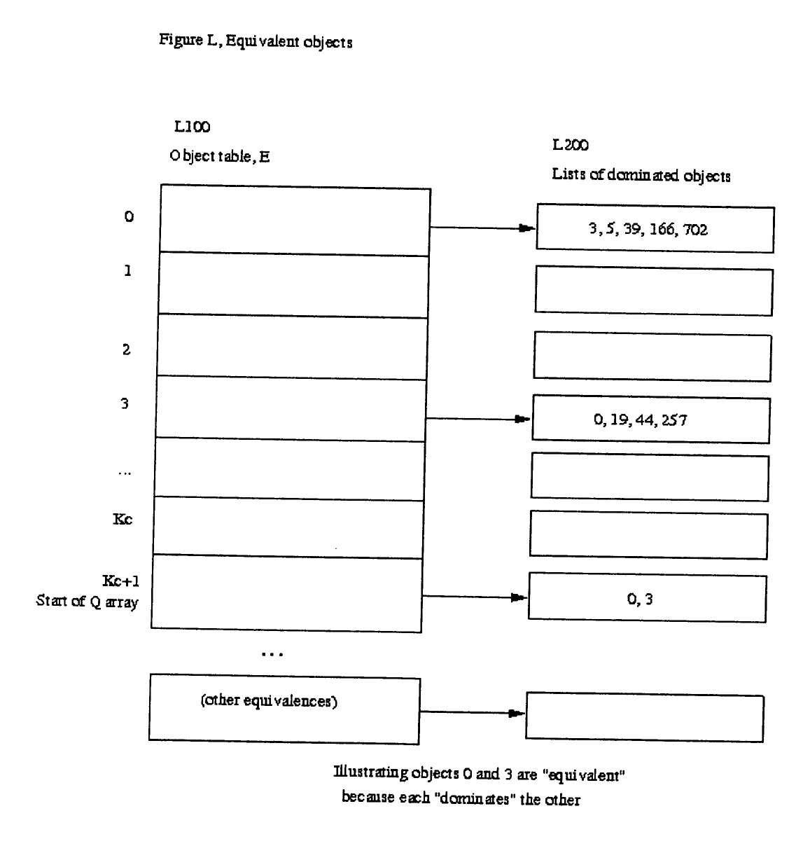

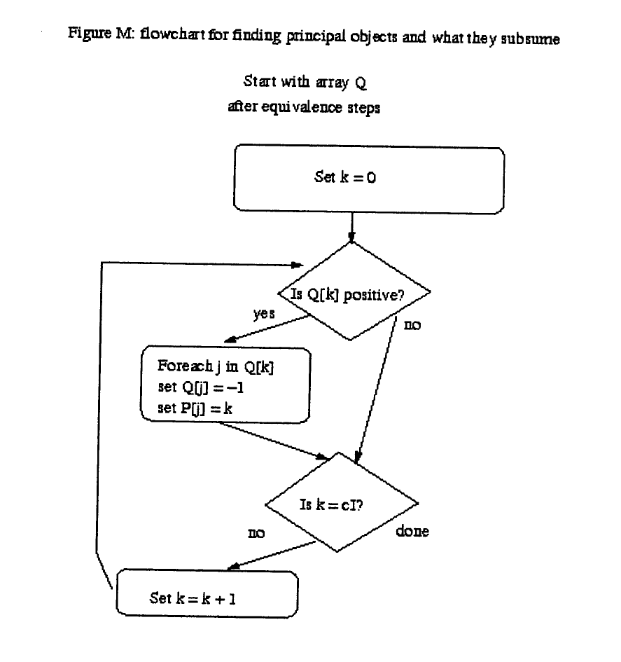

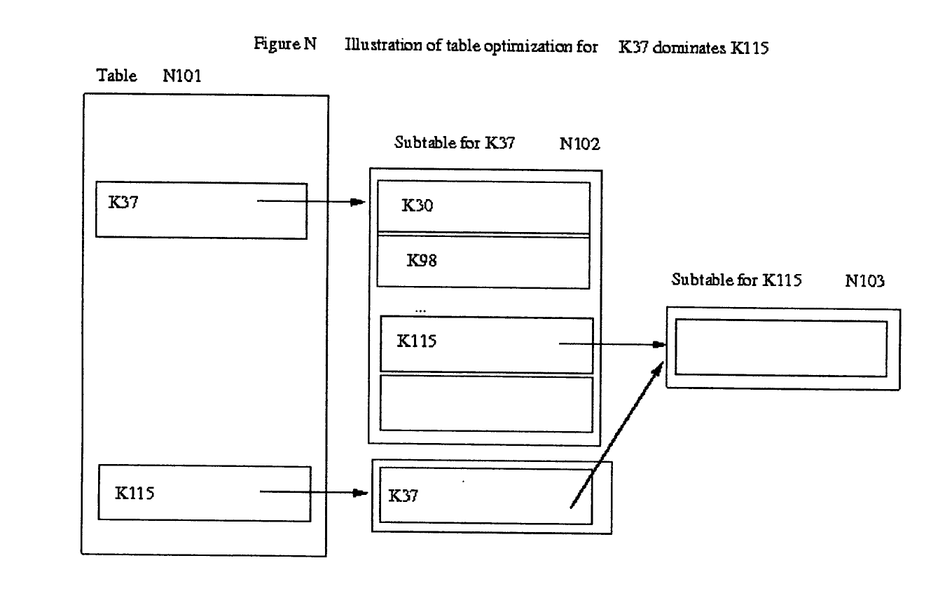

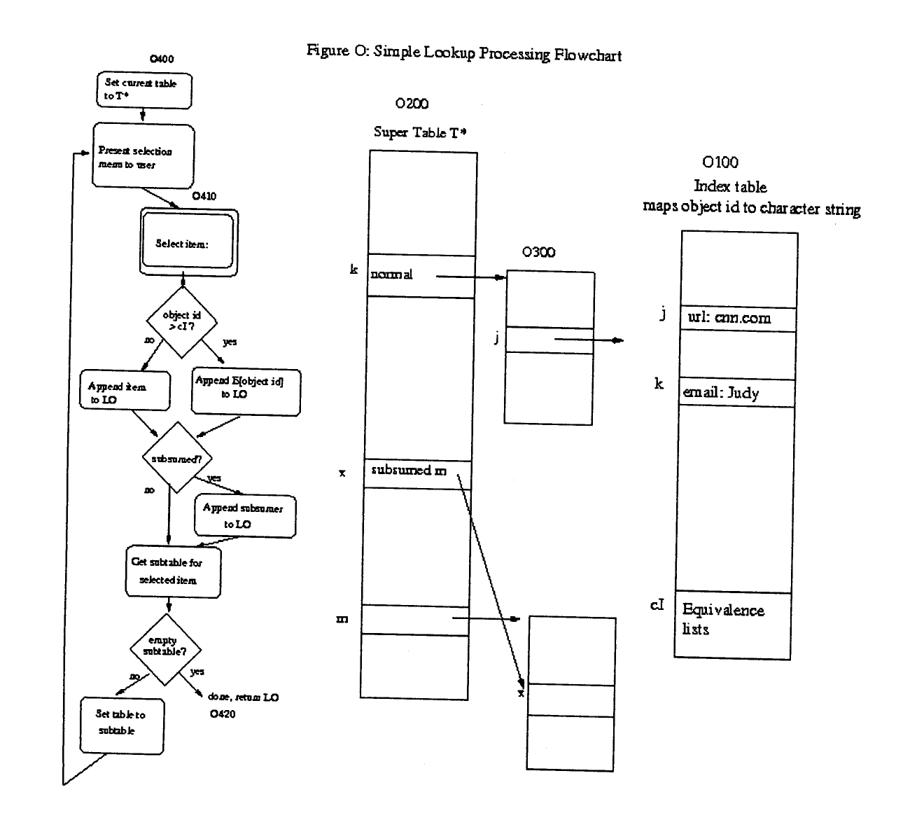

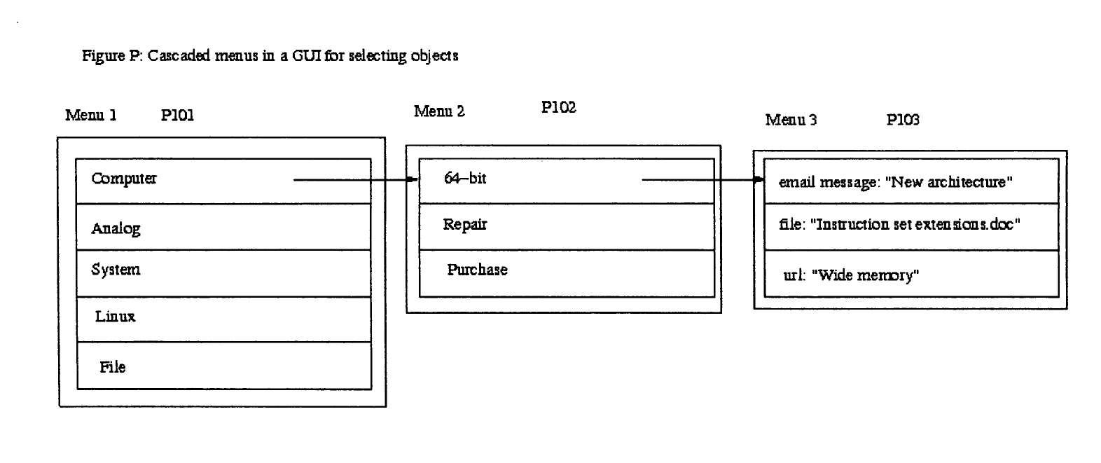

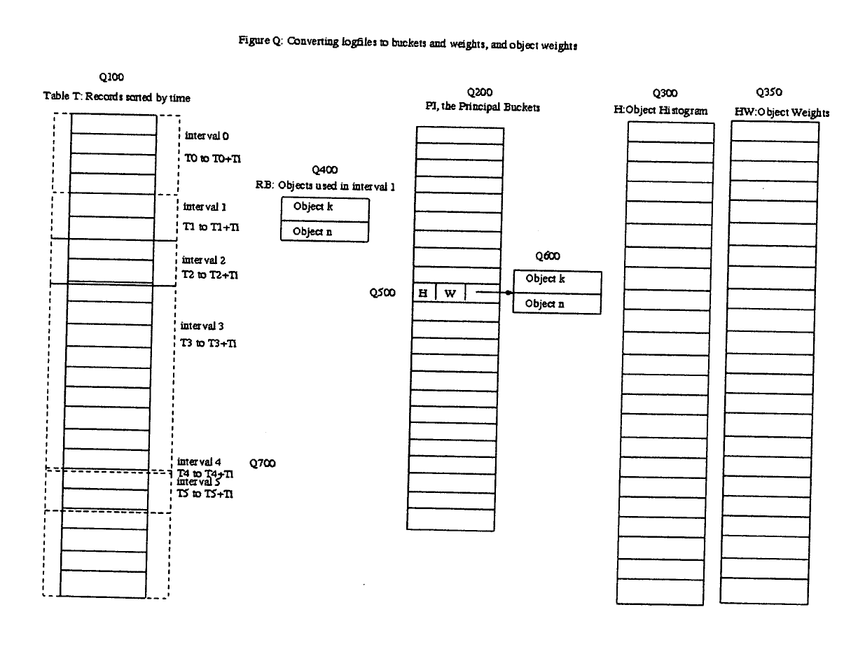

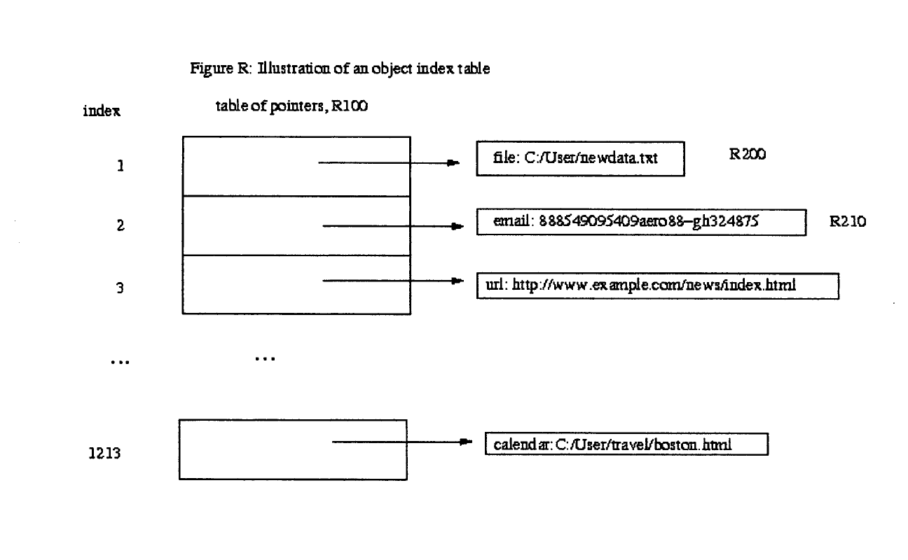

After processing the next steps for building a lookup table, for each object K there will be a memory area TK that represents an ordered lookup table (or bucket list that can be used to build a lookup table) for objects that co-occur with K in the buckets. The invention creates a copy of the index table S, called S′, and each entry in S′ will have the memory address of the table TK associated with each object id. As described below, each recursion level creates a table TK and the entries in the table point to tables from further (higher) levels of recursion. The table that is created from the first recursion level is the master table T* and is used for creating object access selection options (e.g. menus).

[fig-stable-subtable.png, H] Figure H has an example illustrating how a the results of the recursion produce a table (array) of object identifiers uses memory pointers to subtables. The top-level table, T*, or “supertable” (H100) has one entry for teach object in TK. Each entry has a memory pointer to another table (a subtable). In the illustration, the entry for H2 is a memory pointer (H110) to subtable H200. That subtable has an entry for H5, an object that co-occurs with H2. The entry is a point (H210) to a subtable H300. The entry for object H95 is a memory pointer (H310) to another subtable.

[fig-objectlookupflowchart.png, I] FIG. 1 shows the flowchart for building an object-based lookup table.

### Object-Based Lookup Table Steps

Object-based lookup table, Step 1. The invention can begin with a record of type “normal”, “bucket”, or “bucket index”. The processing for “normal” is given here, but processing for the other types is an obvious and easy extension. For each object K in turn, based on the linear ordering of the object id's, the invention copies the buckets for the current object K into a new memory area. In making the copies, the invention does not include the current object. Thus, each copied bucket has fewer items than the original bucket. The invention allocates a memory area that contains the addresses of the new buckets. If the linearly ordered attribute T is associated with the buckets, then it includes T in a record that contains the address of the reduced bucket.

Object-based lookup table, Step 2. The invention examines the members of each bucket and creates an index table SI of all the object indices that occur in the new buckets; each record in the index is for an object K2 that is in at least one of the current buckets for object K. The record contains the object index and the addresses of the buckets containing K2. The size of the index table is the same as the maximum value of the object ids. That number, cI, is the size of the index table I used in building the buckets initially.

Object-based lookup table, Step 3. The weighting function is recalculated in this step using the new bucket set, and the index list SI is sorted based on the weight of each object K2.

This may result one or more buckets that have no members. For such a bucket, the invention creates a record that the special object index (e.g., −1) in the second position in the third position is the address of the memory location containing any additional objects associated with the bucket.

Object-based lookup table, Step 4, last step. A bucket with no members signals the end of processing for the bucket. The address of a record for an empty bucket (i.e., a bucket with no members, which can be denoted with an address of −1) is the return value for the processing routine, and the address of the record is used by the level r−1 processing as the next entry in its sequential list of records for the current object. When the processing for all buckets for the current object have finished, the address of the sequential list of records is the return value.

This is a computer processing technique called recursion. This computation will result in a tree structure that reflects all the information in the original buckets and it suited to quick lookups based on object indices and their relative weights.

At the conclusion of this processing sequence, after all the principal objects in H have been through Object-based lookup table processing steps 1 through 3, including recursions, the table T* can be used to quickly access related objects and their complete object groups.

In this invention, the recursion can stop after a fixed number of levels, and the recursion data structure in the table T* and the object definitions can be saved on a hard drive or in other non-volatile memory. Because the data computed from the first levels of recursion use the majority of the total number of computer processing instructions for building the entire table TK, it is advantageous to store that data for reuse at a later time and to avoid repeating the same processing. Furthermore, by not storing all the data in the fully recursive table, the invention uses less non-volatile memory and can start more quickly later because the amount of data loaded from memory is smaller.

### 5. Creating Subset Trees

In another case of the invention, a “subset tree” is formed for each bucket B[i]. If there is a bucket B[j] such that all object identifiers in B[i] are also in B[j], then B[j] subsumes B[i]. In that case, the subset tree has a “link” from B[j] to B[i]. In a computer representation of a subset tree, a directed link is a memory location at which the representation of a subsumed bucket begins. Each record in the set of records comprising a subset tree has a representation of the members of bucket B[i] that are not in subsets buckets and a list of addresses in the computer memory of subset buckets.

The next section of this invention describes how to create efficient tree-structured graphs from object arrays, and how tree structured graphs can be represented efficiently by coalescing sections of the graph that have redundant information.

[fig-subsettreesflowchart.png, J] Figure J has a flowchart that shows the steps used in building a subset tree, and the auxiliary data structures used for that process.

The invention converts the list of buckets into a lookup table. It begins by representing each bucket in the computer memory by a record of type “bucket”, described above.

The invention processes the list of bucket records in computer memory into an array of records of type “normal”. If A is the object identifier, the list of buckets for A are all the buckets of which A is a member.

The “subsumed” and “equivalence” records are based on objects satisfying special conditions. If the objects are in a “normal” record N, then the objects are defined through these relationships:

### 6. Definitions

Equivalence: Two object identifiers O1 and O2 are equivalent with respect to a bucket list N if for every array in N containing object O1, there is also an object O2 in the same array, and if for every array containing the object O2, the object O1 also occurs in that same array.

Subsumption: The object O1 subsumes O2 with respect to N if for every bucket in N containing O2, O1 is also in that same bucket.

Principal Subsumer: For all objects in a bucket set N that are not themselves subsumed and that subsume O2, the object with the smallest identifier value is the principal subsumer of O2 in N.

A computer instruction sequence can find all cases of equivalence principal subsumption in an array of buckets B by the method described here. The method begins by allocating two distinct memory areas, Q and P, each large enough to hold Ci memory addresses, where Ci is the number of unique objects in the set of buckets B.

Although Ci can be recalculated at each recursion step, it is easiest to calculate it only once, because that is the upper bound on the amount of storage needed for the arrays Q and P. There is also a list C that initially has no elements.

The following steps describe the processing for creating one level of a lookup tree. The last step is the “Breadth first Recursion” step below.

The process of building a lookup tree begins with a list of buckets B, the number unique objects Ci, and a table T*. This data is also called a “bucket record”. After the processing, each entry T*[K] will have a record that is the result of processing the buckets containing the object i. That record will either have a complete subtable on which no further processing is needed, or it will have a partial result that can be used later to produce a complete subtable.

The recursive processing can expand each entry T*[K] into a “subtable” denoted by TK.

Initialization for a lookup table level: Create a variable length array TK. That array will contain the results of computing the lookup table.

The following steps are performed for each object in the set of buckets B. Assume that the current bucket is Bx and the object under examination is O1.

Begin subsumption: Step 1. Set the list C to indicate that it has no elements. There is a variable length list, E, that initially have no elements. After processing the subsumption instructions, E will have a list of records consisting of a new unique identifier and a set of equivalent elements.

Begin subsumption Step 2. Examine each element of each bucket in B to see if O1 is a member of Bx, the current bucket. If it is, include the memory address of that bucket in C.

Now that C has a list of all buckets containing object O1, the invention finds all objects that are equivalent to or subsumed by O1. Each bucket in C is used in turn. The elements in buckets retain their sorted by their object identifiers, from low to high. This description of the invention processing begins with the first bucket in C. The “current bucket” is called Cx and is initially equal to the first bucket in C.

[fig-equivalenceflowchart.png, K] Figure K show the flowchart for equivalence processing. K200 in that diagram is the flowchart for calculating the objects that always co-occur with a particular object; this data is accumulated in the array Q. K300 shows how Q is used to produce the equivalence lists in E.

The equivalence checking is carried out for each element of the current bucket Cx, starting with the first object in Cx and proceeding to each subsequent object in turn. The current object is called O2.

Equivalence Step 1. If the memory location that is O1 locations from the start of Q (i.e., Q[O1)] is zero, then copy Cx to a new memory location and put the memory address of that new location in location Q[O1]. The copying excludes the object O1 from the new array, and the copying preserves the order of the elements.

If Q[O1] is not zero, then it is the address of an array. Examine each element of that array by comparing it to elements in Cx. If an element of O2 in Q[O1] is not equal to any element of Cx, then delete O2 from Q[O1]. The deletion does not change the order of the remaining elements.

Equivalence Step 2. Set Cx to the next bucket in C and repeat Equivalence Step 1. Do this until all buckets in C have been examined.

Begin Subsumption Step 3, final step, Loop. Set O1 equal to the next object, i.e., set O1=O1+1 and go to Begin Subsumption Step 1.

After the subsumption step 3 is finished, the array Q has the information needed for finding equivalent objects. Starting with location Q[0] and proceeding through all the entries in Q in turn do the following: Examine the members of the list Q[i] sequentially. If an element of Q[i] is O2, then sequentially examine the elements of the array Q[O2]. If an element in Q[O2] is equal to i, then objects i and O2 are equivalent. Equivalent objects are accumulated into lists in E. For two equivalent objects i and O2, the invention compares the values and O2 and selects the one that is numerically lesser. The lesser value is j, the other value is k. If E[j] is zero, then set E[j] equal to the list {i, O2}. If E[j] is not zero and not −1, then add O2 to the list at E[j]. Set E[k] equal to −1.

### 7. Equivalence Processing

Equivalence processing: New identifier step. After all objects have been processed, each non-empty item in E that is not equal to zero or −1 is a list of equivalent objects. The invention assigns a new object identifier to each list. If the highest number used for an object identifier is L, then invention assigns a unique number greater than (i.e., L+1, L+2, etc.) to each list in E. This number is a “global” variable: it can be modified at each level of recursion, and the modification is visible to all recursion levels. In this way, the variable L always increases and never repeats a previous value.

Equivalence processing: Rewrite buckets. The computer processing sequence changes the buckets in C so that equivalent objects are removed and replaced by a single instance of their new identifier. For example, if A and B are equivalent and their new object identifier is L1, and if there is an array in C with members {A, B, C, D}, then that array will be changed have the member objects {L1, C, D}. That processing is done by comparing each each non-empty list in E to each bucket B in C. The processing takes the first element in a list of E, call it O1, and checks in turn, each bucket in C to see if it contains O1. If it does, then the processing, copies C, excluding elements of E, and then appends the identifier of the E list to the bucket B. Note that the first element of every equivalence list must be compared to every element of C, because there may be more than one equivalence list in a bucket.

Equivalence processing: Rewrite array Q. For each entry in Q that is not 0 or −1, the invention compares the first entry in the array at Q[O1] to the first element of each equivalence list in E. If the two entries are equal, then the invention rewrites the array at Q[O1] in exactly the same way that the buckets in C are rewritten in the previous step, i.e., the equivalent items are deleted and the identifier of the equivalence list is appended.

Equivalence processing: Add equivalence identifiers to table TK. Each list in E becomes part of a new record added to the table under construction, TK. The record has four items: the type “equivalent”, the new object identifier for the list, and the list of objects.

Equivalence processing: Copy subsumption information. For each list in E, there is one final step. For a list L, iff the first element of the list is O1, and if Q[O1] is not zero or −1, and if the new identifier for L is k, then Q[k] is set equal to Q[O1].

[fig-equivs.png, L] Figure L illustrates the equivalence of objects 0 and 3. In the Q array (labeled L100), the list of objects dominated by 0 includes object 3, and the list of objects dominated by 3 includes 0. The equivalence set {0, 3} is added to table Q as a new entry at position Kc+1.

A principal object is one that subsumes other objects but is not itself subsumed. That is, A is a principal object if there is at least one object B that is not equivalent to A, and for every bucket that contains B, that bucket also contains A. Principal objects can be computed by the method described in this patent. A principal object can be an equivalence set, so it is important that in the following computation the complete set of objects, including equivalent objects from “Final Equivalence Processing”, are used.

The invention uses an arrays (or list) in the computer memory in the process of finding subsumed objects. This array is named P, and it will have as many entries as there are principal objects. The array is initially empty. The computer processing puts data into P based on examination of each entry in array Q that was set in the earlier steps (“Begin Subsumption”). The method depends on having a strict ordering for object identifiers (for example, integer numbers), and the examination of objects must proceed from the lesser identifiers to the greater ones.

The method depends on this fact: if object B is in object A's Q entry, but B is not in A's Q entry, then A strictly subsumes B. For every strictly subsumed object, the computer instructions will add an entry to A's entry in the array P. If A subsumes B, but there is already an entry in P for another object that subsumes B, then no modification is made to P.

[fig-subsume-flowchart.png, M] Figure M illustrates the processing that determines which objects are principal subsumers and which objects they subsume.

[fig-dominates.png, N] Figure N illustrates how a lookup table (N101) can have an optimized memory representation for subsumed objects. In the illustration, K37 subsumes object K115. The table N102 has memory pointers to all objects that co-occur with K37 in the slot labeled “K37”. The slot labeled “K115” does not point to a full subtable for all objects the co-occur with K115; instead, it has a list with the element K37 and a pointer to the subtable of K37 for object K115.

### 8. Subsumption Processing

Subsumption Step 1. The invention uses the array Q from the “Begin subsumption” steps carried out in conjunction with equivalence processing as described above. The invention starts with the first entry in Q (Q[0]) and proceeds through each entry, until the last one (which may be one of the equivalence records added in “Equivalence processing: Copy subsumption information” above. If entry O1 in Q (Q[O1]) is not zero or −1, then it is the address of a list of objects. For each object O2 in Q[O1], set Q[O2] to zero.

Subsumption Step 2. Each entry in Q that is not zero or −1 is the address of a list. If Q[i] is the list L, then for each object in O1 in L, set P[O1] equal to i.

Subsumption Step 3, last subsumption step. After the computer processing has examined all entries in Q to complete the array P, the invention changes the contents of the buckets in C. The processing sequence examines each element in each bucket Cx in C. If an object identifier O1 in Cx has a non-zero entry in the array P, then its entry in table TK is replaced by a record with three items: an identifier of type “subsumed”, the object identifier in P[O1], and the entry in TK for the object P[O1].

After finishing the equivalence and subsumption processing, the invention can reuse the memory locations allotted to Q and P. However, the memory locations for the lists that were pointed to by Q are not reused.

Optional recursion support, breadth first. For each object in TK, the processing steps above have computed C, the “reduced bucket list”. The invention can record that list as a record of type “bucket” and can append that record to the entry for each object in TK.

Alternatively, the invention can use “depth first” recursion to compute the subtable for each object. The recursion uses the reduced bucket list C and the number of objects d. The value returned from the recursion is placed into table position TK[O1].

“Breadth first” Recursion. The data structures that exist after processing all the steps through Subsumption Step 3 are the “state” of the computation. The data structures are: the table under construction TK; the list of buckets B; the number of objects (including equivalent objects) d. Each entry in TK must have the “reduced object list” record computed in the “Optional recursion support, breadth” step described above.

The recursion step is the last step in building one level of a lookup tree.

The “return value” of the lookup table process is a record containing the table TK. The ordering of elements within TK is described in the next sections describing “building lookup trees”.

### Using Indexed Lookup Trees for Users to Select Objects.

In the invention, the names of the objects are presented to the user in a list that is ordered by the weight W. If two objects have the same weight, then the objects are ordered by the value of the object identifier.

In the case of a “super-object” tree, the objects are presented in an a list that has the objects with the greatest weight at the beginning of the list. Because the objects are arrays of identifiers for different kinds of resources on a computer, the text presentation to a user is different than the usual menu which might have file or folder names. Instead, in this invention, the menu will have the text for an abbreviated list of objects that are members of each super-object. When the user selects a super-object from a menu, the invention will “open” each object using methods that are either specified by the operating system (for example, using a text editor for files with names ending in “.doc”) or as specified in a configuration file created for the purposes of this invention.

In the case of the “a priori weighted” tree, the objects are presented in a list ordered so as to put the objects with the greatest weight W at the beginning of the list. After the user selects one object, for example X, the computer processing sequence will present the ordered list of objects from the recursively computed lookup table TK for the selected object. If the user selects object Y next, then the recursively computed table TK′ based on limiting TK to object Y is used. This continues until the user either accepts the selected objects, or there are no more objects available in the table, or the user agrees to select all objects in all remaining subtrees.

In this invention, interactive menus are constructed from the information in indexed lookup trees. The recursive table structure T* is the central structure for building these indexed lookup trees.

[fig-simplelookup-flowchart.png, O] Figure O illustrates the processing sequence that uses the table T* and object-to-name index table to build menus that allow a user to select objects from the clusters calculated earlier.

### 9. Building a Simple Indexed Lookup Tree

Building the selection menus for a simple “a priori weighted tree” is straightforward if there are no “subsumed” records. The invention uses an array LO for items selected by the user in a series of interactions with the user. Initially the array has no information. As the user selects items, they are recorded sequentially in the array, and another variable, initially zero, records the number of items in LO.

Processing begins with the memory area of the super table T*. There is a record M in S for each object in each array of C. The invention creates a menu list with the identifier for each object in the same order that they occur in supertable S. The identifier may stand for a list of objects, as described in the next paragraph, or for a single object, as described later. If the user selects the n-th item from the beginning of the list, then the invention records the name of the item in LO, increments the LO length counter, and then gets a pointer to the memory area for n-th object in M.

If there is a record of type “equivalence”, then it will have the Q array for the table. If the integer n is the first element of one of the records in Q, then n stands for a group of objects. In the menu in the previous paragraph, the object name presented to the user will be the list of object names in the Q record. For example, if the Q record for n=1281 lists three objects {5, 120, 772}, then the menu item for n=1281 will be the text representation of the names of object 5, object 120, and object 772. If the user selects this menu item, then all three objects are appended or inserted into array LO.

If there is a record of type “subsumed” for an object O1, then that record will have the object id of the principal subsumer P and the address of a memory area containing the entry in P's TK table for object O1. The invention will add the objects O1 and P to the list of objects selected by the user, and it will present the objects listed in P's TK for O1 as the list of further objects that the user might select.

When the user selects an object X from a menu, the invention will find the index of the object named X in the table T* (or a subtable, TK, of T*). This can be done in one of two ways. If the menu system being used allows extra information to be stored in items and if that information is easily retrieved from the menu system interface for a selected item, then the records' indices will be added to the menu system with each object name. For example, “file example.doc” and its index 772 would be information contained in a menu item; the index would not be displayed, but would be available to the software if the user selected “file example.doc”. If the menu system does not allow extra information like the index to be associated with items, then the invention will create use a “reverse index” for the table; in a reverse index, an array has a character string entered at each position, and the method of lookup for a particular object name is to compare it to the data in each array position until the character string in the array matches the character string in the lookup. If that is at position n, then n is the index to be used when accessing table TK as well.

[fig-menus.png, P] Figure P has an illustrative example of how a user might proceed through “menu” selections for objects that are indexed by keywords. Menu 1 (P102), has an entry for the word “computer”; if the user selects that, then a related word, determined by examining log data such as the user's Internet search terms and email subject lines, can be selected from a menu of 3 items (“64-bit, Repair, Purchase); selecting “64-bit” results in a submenu of 3 objects that are associated with both words, i.e., an email message, a hard drive file, and a web location (url). One or more objects, when selected, will be opened by the associated application software.

### 10. “On-The-Fly” Compact Lookup Trees

The invention computes compact lookup trees interactively in order to minimize the use of computer memory. These “on-the-fly” lookup trees only compute one level of the table TK at a time. That is, the recursion does not happen until it is needed; the need occurs when a user has selected some objects from menus, for example, object A and then B, and the table entry for object B is of type “bucket”. The invention uses the “bucket” record to compute, recursively, the further selection lists for object that occur with A and B in the master list.

The invention computes the first level of recursion, TK[0] using the data in a collection C. This table resides in computer memory or in persistent storage for as long as the collection C is useful for the computer user.

The table TK[0] is used to create an indexed lookup tree and to present the user with a selection of objects. If the user selects an object X from TK[0], then the invention adds X to a list LS of selected objects and then recursively computes TK[X,1] as described in 14.b and 15.d.9. The invention uses TK[X,1] to build another indexed lookup tree and to present a menu of objects to the user. If the user selects an object Y, then the invention adds Y to LS and recursively computes a subtable as before. This continues until the user indicates that no more selections are needed or until no more objects are available.

### 11. Using Weighted Clusters with Computer Applications Involving User Selections

The description of the invention emphasizes general object collections such as files and urls, but it is particularly useful when applied to other things in the metadata collection described earlier. Messaging systems, such as email handlers, have “to” and “cc” and “bcc” fields that give the Internet names of correspondents. The clustering methods of this invention are particularly useful for finding groups of correspondents to whom email is commonly addressed. If the weighting function gives greater weight to those correspondents in “to” lines than those in “cc” lines, a natural hierarchy of correspondents results. When this hierarchy is used in an email reader as a selection menu of the type described previously, then a user can select any single correspondent and be quickly guided through the selection of appropriately related additional correspondents.

Users frequently annotate received email through their email software application by filing it in “folders” or other named repositories. This invention can use the email metadata or data from email headers as items for clustering. When a user needs to select a folder for a particular email message, this invention can use the clusters to select the folder most likely to be used for a new message. The invention's embodiment of this is through application extensions of email applications.

The invention can be used with any kind of computer application data that uses named fields and is processed applications that interactively associate the named fields with data. Three examples are described here are form fill-in, calendars and contacts, and Internet search queries, but the invention is not limited to these illustrative examples.

A common representation for the user supplied content in text templates used by software application is pairs of character strings where one string is the name of the data item (e.g., “address” and the second is the value supplied by the user. An example of a typical pair might be {“address”, “1234 Easy Street, Ourtown”}. This invention can perform clustering operations to build “buckets” by using these pairs as input to the process. The user's home address will usually show up as an item common to many used templates, as will his telephone number. These items will show up in buckets with high “weights” in the clustering process. They would then be offered to the user automatically when filling out new forms that have the same or similar data item types. The embodiment of this is done through software extensions to form fill-in software such as those that are integrated with “Portable Document Format” (pdf) readers.

Items in a user's online calendar or “to do” list will have dates and times and descriptions. This invention can analyze the data items to develop groups of tasks that commonly occur in conjunction with one another. The metadata collection methods of this patent can collect information that is tagged with identifying types such as “appointment”, “meeting”, “contact” and the values for those types, such as “dentist”, “work team”, or “John Smith”. The type-value pairs form items that can be analyzed into buckets, and those items that commonly occur together, such as “appointment: dentist” and “contact: Dr. Barnard” form cluster that can be used to prompt the user interactively when forming a new appointment. The same method applies to contact lists.

For Internet search queries, this invention has a powerful method of identifying terms of interest to a user and for using them in subsequent queries. For example, a user might frequently use the words “napier” and “illinois”. These terms would show up as heavily weighted in buckets with other terms such as “restaurant” or “school”, and thus, when the user starts a new search and types on of these names, the invention will interactively offer the related terms in the clusters as part of a selection menu. The embodiment of this is done through an application extension to a browser application or as a standalone “quick search” application.

Another use of the invention is for collecting clusters of objects that are the names of software applications that the user relies on frequently. For example, the user may have a photograph editor application that is used for his digital camera photos. The editor software would show up in log files as being accessed with type “execute” or “run”. Any duster computed by the methods of this invention that has a software application can be distinguished as a “utility” and put into a special system menu for selecting programs. When a user selects a “utility” item, the software application in the cluster is started, and any objects in the cluster that can be “opened” by the application are automatically opened.

All of the clusters of application data are themselves “super objects” that can be used in the formation of selection menus of heterogeneous objects as previously described. The use of an Internet search engine to find urls associated with a group of keywords, for example, might have occurred in the same time interval with adding an appointment to a calendar and reading a formatted document with a viewer. The words used for the Internet search constitute an “object”, as do the named items and their values in the appointment.

### Operation of Invention

The invention operates by collecting data, analyzing data, forming groups, representing the groups in the computer memory, and presenting the groups and group items to users when they are selecting items to be used in accomplishing a task on the computer.

The data collection is accomplished by creating logfiles and data with time indicators. These are a normal part of the operation of many computer applications and computer operating systems. Other data is collected by using application software extensions (also known as add-ons or plug-ins) and by active monitoring of computer file creation and modification times as recorded by an operating system. Other data is taken from computer files that are written by software applications, such as calendar files and email messages.

The invention creates computer data structures that have the unique name of an object, such as a computer file name or an email identifier, a time (or other linear attribute), a type which is derived from metadata associated with the item (such as its “file extension” or other data in the logfile entry), and one or more attributes such as type of use (e.g., read, write, reply, etc.). The invention sorts the records by the linear attribute, and the invention uses an interval measure (such as “5 minutes”) to define “buckets” of records that have a linear attribute value that is within each interval.

The invention assigns a measure of importance to groups of objects that are in a bucket and to objects that are in those groups. The collection of object names in a bucket comprises a cluster. The unique identifier for the cluster is the sorted list of object names in the bucket of records. The bucket is assigned a weight based on the linear attribute. The weight of the cluster is the sum of weights for all instances of the cluster across all buckets. Each object in a bucket is also assigned a weight according to its attributes, and the weight of an object with respect to a cluster is the sum of its weights in all instances of that cluster across all buckets. The invention computes a list of all clusters and the weights of objects in each cluster.

Clusters that occur very frequently (for example, in more than 50% of all intervals) or that occur very infrequently (for example, in less than 0.1% of all intervals) are not retained in the list of clusters.

Objects that occur very frequently (for example, in more than 60% of all clusters), are removed from the cluster lists.

Those clusters that remain are sets of objects that are commonly used together, with respect to the linear measure. Sets can be organized into a mathematical structure called a lattice, based on the subset relation between sets. The invention performs this organization of the clusters in a recursive manner, using top-down breadth-first recursion. The clusters and items within clusters are ordered in the computer memory according to the value of their weight, and items with greater weight are put before items with lesser weight.

The ordered clusters are computed periodically on a computer system, and they are saved in permanent storage.

The invention can combine new data about clusters with old data. A previously stored set of cluster data, based on, for example, logfiles from Feb. 2, 2010 to Sep. 10, 2010, can be combined with clusters computed from Sep. 15, 2010 to Jan. 15, 2011. All clusters and cluster members in the earlier set will have their weights multiplied by a reducing factor that depends on the weighting function used in the clustering algorithm. The two datasets are then sorted and merged by adding the weights for two instances of the same cluster. The combined dataset becomes the new cluster set.

The invention uses the lattice organization to form “selection menus” that are used in computer operating systems and applications to allow the user of a computer system to use a mouse or keyboard or other device to choose items from a list.

The selection menus are generated when a user begins a selection function. The invention constructs the initial “menu” lists from the file of clusters. The process is initiated by the user's “clicking” of a button on a mouse when the pointing device shows a cursor on the computer screen “desktop” or other area devoted to user interactions. In one embodiment, the menu list begins with a list of all clusters ordered by weight. The user can select one or more clusters, and then all the objects in the cluster are processed by the operating or applications using an appropriate operation for “opening” the object. For example, if the object is a Universal Resource Locator (URL), then an application known as a “web browser” will open the URL.

In another embodiment, the user, having selected a duster from a menu, will select individual objects from that cluster, each one being opened by an appropriate application. The objects are presented to the user in an order determined by their weights.

In another embodiment, the invention presents objects to a user in an order based on the objects' weights. Each time the user selects an object, the software of the invention saves that object and presents a list of all objects that occur in any clusters containing the selected object; the objects are ordered by the sum of their weights as noted in each cluster containing the selected object. This process is repeated recursively. The recursion uses clusters that are derived from those containing the selected object. The selected object is deleted from copies of the cluster that contain it, and those dusters become the computational objects of the recursion. This process continues until the clusters are exhausted or the user indicates that the selections are finished.

In the process of selecting and presenting clusters and objects, the invention makes use of two representations that efficiently use the computer memory and processor and thus make the selection process faster. At any stage of the processing, objects that occur together in all dusters are “equivalent” and are represented as a single item in the computer memory. Further, an item that always occurs in clusters with other items is “subsumed”, and for each subsumed item, the invention chooses a unique item (called the “principal subsumer”) from among those that it occurs with. The clusters for the subsumed item is represented in the computer memory by the principal subsumer and the computer memory address of the clusters for principal subsumer item that contain the subsumed item (the clusters having been copied without the principal subsumer, and without the subsumed item).

In one embodiment the invention recursively computes all the clusters before presenting any item to the user for selection.

In another embodiment, the invention computes one level of the recursion each time the user selects an item. When the user has finished the selection process, or as the user selects items, those items are “opened” by appropriate software application processes based on the objects' types.

The embodiments described above use various applications to operate on the heterogeneous objects in a cluster. In a different embodiment, the invention uses homogeneous objects such as search keywords, text items in calendar entries, email addresses, or “type-value” pairs from file objects created and used by software applications such as calendar or appointment application, email readers, etc. The invention parses the file objects into records with the value for application data types as the “items” for building clusters. The invention uses a linear attribute such as the time of the file creation or modification to build buckets and clusters as described above. The invention uses application extensions to provide selection menus based on the clusters. The application extensions are activated when a user indicates through a pointing device or keyboard or other interaction device that a selection activity is being initiated, or when the application automatically requires a selection operation.

### CONCLUSIONS, RAMIFICATIONS, AND SCOPE

This invention provides a means to significantly change how users interact with computer software when selecting or choosing objects or items, thus saving time and mental effort. The ease of use of a computer is important to anyone who owns one, whether for private or professional use. This invention makes the computer more useful for everyone who uses it.

The invention relies on collecting data during the course of a person's use of a computer, its file system, and its application software and operating system. The data is analyzed, organized, and used to guide a person through any selection task that uses selection lists or menus.

The exact embodiment of 2 phases of the invention (collection and presentation) can be in any of several ways depending on how the operating system stores information, how applications save history data, how application extensions are constructed, and how the software that controls the graphical user interface for a “desktop” or operating system is constructed. For example, on the Linux operating system the “find” program can locate files that have been “opened”. The “find” program is part of an application that can run on the Microsoft Windows operating system, or equivalent functionality exists in Microsoft applications. Every calendar program keeps user data in a file somewhere in the user's home folder, and that data can be accessed for discovering appointments. Similarly “contacts” lists and email history logs can be customized through user settable variables and the log files can be read and analyzed. This invention is not limited to these examples and can use any logfile format that is known to a software developer.

User selection menus have been part of applications and operating systems for many decades, and they have several embodiments in graphical user interfaces today. These are bundled with operating systems such as Microsoft Windows or can be chosen by a user on the Linux operating system from such choices as the “X Windows” system or the Gnome system. Software developers can use application programming interfaces and software libraries to customize selection menus or “widgets” in a variety of styles. This invention can use embodiments from any of these systems.

Several kinds of computer “objects” are used as examples of things that can be aggregated into clusters in this description. The invention is not limited to these examples, and any identifiable object on a computer that is accessible via software interfaces is part of the set of things that can be analyzed by the cluster methods.

The invention specifically covers clusters that are built from subset lattices, but it also covers clusters that themselves become objects. The invention covers selection methods that choose clusters item-by-item as well as methods that choose entire clusters at once.

The specifics in the description show how sets of related objects are discovered and used in a computer system that interacts with a user and how those object sets can be presented to a user for selection, but the specifics should not be construed as limiting the scope of the invention. There are many kinds of selection menu interfaces in a computer system and its application software, and this invention is not limited to any particular one. Several examples of computer system “objects” are given in the description, but the invention is not limited to those objects. The description notes some useful values for the size of a time interval, coefficients for use in a “heavy-tail” function for linear attribute weights, and the percentages of instances that would result in exclusion of an object from clusters because it is too frequent or too infrequent. These values are included as examples and do not limit the invention to the specifics.

Thus, the scope of the invention should be determined by the appended claims and their legal equivalents, rather than by the examples given.

### REFERENCES CITED IN THE PATENT

[Knuth] Knuth, Donald E. “The Art of Computer Programming”, Vol. 3, Addison-Wesley-Wesley, 1973
[Aho1974] Aho, Alfred V., Hoperoft, John E, and Ullman, Jeffrey D., “The Design and Analysis of Computer Algorithms”, Addison-Wesley, 1974
[Aho1983] Aho, Alfred V., Hopcroft, John E, and Ullman, Jeffrey D., “Data Structures and Algorithms”, Addison-Wesley, 1974
[Aho3] Alfred Aho, Monica Lam, Ravi Sethi, and Jeffrey Ullman, “Compilers: Principles, Techniques, and Tools (2nd Edition)”, Addison-Wesley, 2006
[RFC2045] Freed, Ned and Borenstein, N., “Multipurpose Internet Mail Extensions (MIME)”, http://tools.ietf.org/html/rfc2045X, 1996
[Ritchie] Kernighan, Brian and Ritchie, Dennis, “The C Programming Language”, Prentice-Hall, 1978
[RFC2616] R. Fielding et al., “Hypertext Transfer Protocol—HTTP/1.1”, http://www.w3.org/Protocols/rfc2616/rfc2616.html, 1999
[Pareto] Lorenz, M. O. (1905). Methods of measuring the concentration of wealth. Publications of the American Statistical Association. 9: 209âε219. [RFC131] Rivest, Ron, “The MDR Message-Digest

### REFERENCES CITED IN THE PATENT

[Knuth] Knuth, Donald E. “The Art of Computer Programming”, Vol. 3, Addison-Wesley-Wesley, 1973
[Aho1974] Aho, Alfred V., Hopcroft, John E, and Ullman, Jeffrey D., “The Design and Analysis of Computer Algorithms”, Addison-Wesley, 1974
[Aho1983] Aho, Alfred V., Hopcroft, John E, and Ullman, Jeffrey D., “Data Structures and Algorithms”, Addison-Wesley, 1974
[Aho3] Alfred Aho, Monica Lam, Ravi Sethi, and Jeffrey Ullman, “Compilers: Principles, Techniques, and Tools (2nd Edition)”, Addison-Wesley, 2006
[RFC2045] Freed, Ned and Borenstein, N., “Multipurpose Internet Mail Extensions (MIME)”, http://tools.ietf.org/html/rfc2045X, 1996
[Ritchie] Kernighan, Brian and Ritchie, Dennis, “The C Programming Language”, Prentice-Hall, 1978
[RFC2616] R. Fielding et al., “Hypertext Transfer Protocol—HTTP/1.1”, http://www.w3.org/Protocols/rfc2616/rfc2616.html, 1999
[Pareto] Lorenz, M. O. (1905). Methods of measuring the concentration of wealth. Publications of the American Statistical Association. 9: 209-219.
[RFC131] Rivest, Ron, “The MD5 Message-Digest Algorithm,” http://www.ietf.org/rfc/rfc1321.txt
[Bloom] Bloom, Burton H. “Space/time trade-offs in hash coding with allowable errors”, Communications of the ACM 13 (7): 422-426, doi:10.1145/362686.362692, 1970

### STATEMENT REGARDING FEDERALLY SPONSORED RESEARCH OR DEVELOPMENT

No part of this invention was part of a Federally Sponsored Research or Development contract or grant.

1. The organization of heterogeneous computer objects into ordered clusters which are commonly accessed at the same time by a user of a computer system, such clusters (also known as “groups” or “sets”) determined by
a means of combining linear and exponential functions of attributes of an object's usage history to determine the importance (“weight”) of that object;
a means of combining linear and exponential functions of the attributes of group members to determine the importance (“weight”) of a group;
a means of using object data including the time of use, frequency of use, and the method of use where the method is derived from “metadata” or attributes of object usage, such as “read” and “write” and other items recorded by computer applications and operating systems;
the presentation of the clusters to a user making a selection using interactive interfaces from the computer operating system or application “menus” or other selection means;
the use of the object “weight” to determine the order in which items are presented to the computer system user.

2. The method of claim 1 for discovering clusters using an incremental computation in which prior results can be easily combined with new results without recomputing the prior results by using a linear or exponential function in which all previous weights can be changed by multiplying each one by the same numeric value.

3. The method of claim 1 for discovering clusters including using a means of excluding from clusters those items that are not useful for user selection (e.g., an item is “not useful” if it occurs too frequently or has a low “weight” relative to other objects.

4. The clusters of claim 1 when designated as “superobjects” and organized into selection lists for the user of a computer systems to choose from by using a single name or action for the entire collection.

5. The clusters of claim 1 when designated as “superobjects” and organized into selection lists for the user of a computer systems to choose from by using a single name or action for the entire collection and having that selection followed by “opening” each object using a computer application program that can operate on that object.

6. The means of claim 1 for creating clusters when used with collections diverse information about computer objects including file attributes discovered through comprehensive file system scans and application extensions that enter information into logfiles, such data being used as input to the cluster formation process.

7. The cluster discovery process of claim 1 when based on collections of diverse information about application objects including email folders and calendar entries when obtained from application extensions that enter information into logfiles that can be used as the basis for cluster formation;

8. The cluster discovery process of claim 1 used with software that parses application configuration and history files into logfiles that are used as the basis for cluster formation.

9. The use of the weighted clusters of claim 1 with computer application interfaces that present items through a selection process in order to automatically find and suggest items that are frequently used in conjunction with one another.

10. The cluster discovery means of claim 1 when used with data recorded from a computer user's interaction with an email program that records the mail headers “to”, “from”, “cc” and other data, such data being parsed into records in which the destination email addresses are the “objects”.

11. The cluster formation means of claim 1, based on data collected from email interactions, for presenting email address selections to a user who is composing an email message, based the probability that a user will address an email message to more than one person, and that if the user selects one person, then others in a weighted cluster are likely to be included as recipients of the message.

12. The cluster selection of claim 1 when based on email logfiles to present lists of items for email fields (i.e., fields commonly referred to as “subject”, “from”, “to” and “cc”, etc.) during the composition and/or completion of the message.

13. The cluster formation and selections of claim 1 when based on email logfiles that include information about the names of “folders” used for saving email messages, and the information about the email header (such as “to”, “from”, etc., but not limited to these) fields in those messages, used to create selection menus in an email application when the user is saving an email message for later retrieval by using the folder name.

14. The clustering and selection means of claim 1 when used with data from calendar or appointment applications, using fields such as, but not limited to, “time”, “place”, and “contact”; the clustering being based on fields with values that are commonly used together, and in which if a user selects the contents of one field, the most likely other fields are presented for use, based on prior calendar entries or appointments.

15. The clustering and selection means of claim 1 when used with any data in a “template” with named fields and values, such as but not limited to a travel plan with items such as “transportation”, “lodging”, etc.; in a computer application using these fields and presenting selections to a user, the application uses groups of items that are in clusters and orders the items according the “weights” as computed using the means of claim 1.

16. The clustering and selection means of claim 1 when based on data from prior travel plans; when a person uses a computer application that creates or modifies a travel plan, the selections for each item in the plan are based on the user's history of forms for prior plans.

17. The clustering and selection means of claim 1 when used with a user's history of keyword searches as kept by a web browser history log or other data logging method; the words in searches are assigned weights based on usage history and organized into dusters; when the user of a computer system begins a new search, the software application presents ordered choices based on the subset lattice of the clusters.

18. The clustering and selection means of claim 1 when a software application is a member of the cluster, as determined by using information from the computer operating system; when the cluster is selected by the user, the software application or applications in the cluster are automatically started (“executed”).

19. The representation in computer memory of ordered groups of objects for the purpose of allowing a user to quickly look up object groups by selecting member objects which may be common to more than one group, where each selection excludes those groups that do not contain the selected object. The invention uses recursively computed subset lattices to represent the information in the computer memory.

20. The means of claim 19 used with the discovery of “equivalent” items and collapsing them into a single item in computer memory.

21. The means of claim 19 used with the discovery of “subsumed” items and using memory pointers to eliminate redundant storage for them, by using a special compact form for such objects in which the subsumed objects do not duplicate previously calculated structures but instead use the representation of a “principal subsumer” and a memory pointer to represent the subset;

22. The means of claim 19 using partial recursion for computing graph structures called “lookup tables” from input data comprised of object sets; the partially computed lookup tables can be efficiently stored in non-volatile memory and used for creating complete lookup tables at a later time;

23. The means of claim 19 used with the creation of multiple compatible representations of the lookup tables; these representations allow each table entry to have a choice of representations from multiple types: a list of sets, a subtable, a list of pairs consisting of an object and a pointer to further subtables.
